(19) United States
(12) Patent Application Publication
(10) Pub. No.: US 2014/0304551 A1
(43) Pub. Date: Oct. 9, 2014

(54) PROGRAM ANALYSIS SUPPORTING DEVICE AND CONTROL DEVICE

(71) Applicants: Satoru Nakai, Tokyo (JP); Akikazu Kato, Tokyo (JP)

(72) Inventors: Satoru Nakai, Tokyo (JP); Akikazu Kato, Tokyo (JP)

(73) Assignee: MITSUBISHI ELECTRIC CORPORATION, Chiyoda-ku, Tokyo (JP)

(21) Appl. No.: 14/113,490

(22) PCT Filed: Dec. 17, 2012
(86) PCT No.: PCT/JP2012/082703

§ 371 Date: Oct. 23, 2013

(51) Int. Cl. G06F 11/36

(52) U.S. Cl. CPC G06F 11/3692
USPC 714/38.1

(57) ABSTRACT

A program analysis supporting device includes an analysis-condition-setting operation unit a variable-dependency-relation extracting unit and a variable-dependency-relation-display processing unit, in which the analysis-condition-setting operation unit sets a first condition related to a device for which a further forward or backward device dependency relation is not extracted or a second condition related to a device for which a further forward or backward device dependency relation is extracted, the variable-dependency-relation extracting unit extracts a forward or backward device dependency relation from the ladder program starting from the set start point not to extract a further forward or backward device dependency relation concerning a device matching the first condition and to extract a further forward or backward device dependency relation concerning a device matching the second condition and generates a first extraction result, and the variable-dependency-relation-display processing unit displays a device dependency relation according to the first extraction result.

### FIELD

The present invention relates to a program analysis supporting device and a control device.

### BACKGROUND

As a function for debugging whether a controller is correctly operating concerning a ladder program, a sampling trace function is known. The sampling trace function is a function for acquiring (sampling), at a fixed period (sampling period), data (trace data) indicating a state of a device designated at designated timing and storing the acquired trace data in a predetermined memory (sampling trace memory). Details of the sampling trace are described in Non Patent Literatures 1 and 2.

The device referred to herein indicates a memory address of a PC to which an input or an output between a measurement monitoring control target of the PC and the PC is allocated and indicates a memory address internally used by the PC. For example, in a PC described in Non Patent Literatures 1 and 2, device characters are determined in advance according to data types, for example, a memory address to which an input is allocated is referred to as X device, a memory address to which an output is allocated is referred to as Y device, an internally-used bit data (an internal relay) is referred to as M device, a memory address used for communication is referred to as B device, and a memory address indicating occurrence of an error is referred to as F device. Addresses of the devices are hexadecimal representations concerning the X device, the Y device, the B device, and the like and are decimal representations concerning the M device, the F device, and the like.

### CITATION LIST

### Patent Literature

Patent Literature 1: WO2010/095289

### Non Patent Literature

Non Patent Literature 1: “QCPU Users Manual (function explanation/program basics edition)” Mitsubishi Electric Corporation, Manual number SH-080473
Non Patent Literature 2: “GX Developer Version 8 Operating Manual” Mitsubishi Electric Corporation, Manual number SH-080356
Non Patent Literature 3: “Program Slicing Technology and Application” Takao Shimomura, Kyoritsu Shuppan Co., Ltd. ISBN4-320-02743-4
Non Patent Literature 4: “Mitsubishi Numerical Control Device PLC Programming Manual” Mitsubishi Electric Corporation, Manual number IB-1500035-F

### SUMMARY

### Technical Problem

Concerning devices suspected as a cause of a defective operation, if sampling trace is performed and contents of the devices are analyzed by, for example, being displayed as a timing chart, it is expected that the cause of the defective operation is specified. However, there is a limit in a memory size that can be subjected to the sampling trace at a time.

The inventor examined the sampling trace and found that there are two problems. As a first problem, because there is a limit in the memory size that can be subjected to the sampling trace at a time, it is necessary to narrow down the devices suspected as the cause of the defective operation. As a second problem, the sampling trace is sometimes performed for devices including a large number of devices (e.g., operations of the devices) not substantially directly contributing to specify a cause of a deficiency.

As a technology for solving the first problem, there is a slicing technology described in Non Patent Literature 3. That is, in a ladder program, (a directed graph of) dependency relations of devices (variables) are extracted. It is possible to narrow down devices suspected as a cause of a defective operation out of the program by using (the directed graph of) the dependency relations of the devices.

However, in recent years, the ladder program is becoming larger and more complicated. Therefore, even if (the directed graph of) the dependency relations are used, it is still difficult to narrow down the devices suspected as the cause of the defective operation.

On the other hand, Patent Literature 1 describes that a plurality of analysis conditions (an analysis command, an analysis target, etc.) are freely combined to perform a program analysis. Consequently, according to Patent Literature 1, it is possible to quickly specify, based on a result of the program analysis, a place to be edited.

That is, if the technology described in Patent Literature 1 is used, it is considered possible to extract only (a directed graph of) dependency relations more deeply matching the analysis conditions out of (a directed graph of) enormous and complicated dependency relations by performing logical operations AND/OR/NOT of (a directed graph of) dependency relations.

On the other hand, debug work is performed using a production facility incorporating a PC. As explained above, the debug work is performed by connecting the personal computer and the PC. Besides, the debug work is performed using a display and an operation button included in the production facility.

In order to use the technology described in Patent Literature 1, an advanced user interface for freely designating a plurality of analysis conditions in combination is necessary. Therefore, when the debug work is performed using the display and the operation button included in the production facility, an operation method for freely designating the analysis conditions in combination within a limited range of these user interfaces has to be realized. Therefore, it is likely that, compared with the case of the personal computer, the number of operations markedly increases and, all the worse, more labor and time are required.

For example, in the technology described in Patent Literature 1, when the debug work is performed using the display and the operation button included in the production facility, because the number of operations is markedly large, it is likely that operation mistakes are easily induced and the analysis conditions are not appropriately combined. Therefore, it tends to be difficult to narrow down the devices suspected as the cause of the defective operation. As a result, the first problem is left unsolved.

In Patent Literature 1, there is no description concerning reproducibility of a deficiency. Concerning measures against the deficiency with low reproducibility, there is no description at all concerning how dependency relations deeply related to the deficiency are extracted. That is, the second problem is also left unsolved.

The present invention has been devised in view of the above and it is an object of the present invention to obtain a program analysis supporting device that can extract, when the debug work is performed using the display and the operation button included in the production facility, (a directed graph of) dependency relations deeply related to a deficiency out of (a directed graph of) enormous and complicated dependency relations with a small number of operations and display (the directed graph of) the dependency relations.

### Solution to Problem

In order to solve the above problems and achieve the object, a program analysis supporting device according to one aspect of the present invention includes an analysis-condition-setting operation unit that sets a ladder program to be analyzed and a start point of a dependency relation desired to be extracted, an analysis-processing executing unit that includes a variable-dependency-relation extracting unit that extracts a forward or backward device dependency relation from the ladder program, an analysis-result-display processing unit that includes a variable-dependency-relation-display processing unit that displays the extracted device dependency relation, and a circuit-display processing unit that displays the ladder program, in which the analysis-condition-setting operation unit sets a first condition related to a device for which a further forward or backward device dependency relation is not extracted or a second condition related to a device for which a further forward or backward device dependency relation is extracted, the variable-dependency-relation extracting unit extracts a forward or backward device dependency relation from the ladder program starting from the set start point not to extract a further forward or backward device dependency relation concerning a device matching the first condition and to extract a further forward or backward device dependency relation concerning a device matching the second condition and generates a first extraction result, and the variable-dependency-relation-display processing unit displays a device dependency relation according to the first extraction result.

### Advantageous Effects of Invention

According to the present invention, because the first condition or the second condition are used, it is possible to efficiently narrow down the device dependency relations using the directionality of the device dependency relations. As a result, it is possible to extract only (a directed graph of) dependency relations deeply related to a deficiency out of (a directed graph of) enormous and complicated dependency relations without designating a large number of analysis conditions (an analysis command, an analysis target, etc.) in combination. That is, it is possible to extract, when the debug work is performed using the display and the operation button included in the production facility, (a directed graph of) dependency relations deeply related to a deficiency out of (a directed graph of) enormous and complicated dependency relations with a small number of operations and display (the directed graph of) the dependency relations.

### BRIEF DESCRIPTION OF DRAWINGS

FIG. 1 is a diagram illustrating a hardware configuration of a program analysis supporting device according to a first embodiment.

FIG. 2 is a diagram illustrating a functional configuration of the program analysis supporting device according to the first embodiment.

FIG. 3 is a diagram illustrating the configuration of an analysis-condition-setting operation unit in the first embodiment.

FIG. 4 is a diagram illustrating a directed graph corresponding to a forward dependency relation extraction result in the first embodiment.

FIG. 5 is a diagram illustrating the configuration of a ladder program in the first embodiment.

FIG. 6 is a diagram illustrating a forward analysis condition setting example that takes into account a device type in the first embodiment.

FIG. 7 is a diagram illustrating a directed graph corresponding to a forward dependency relation extraction result example that takes into account a device type in the first embodiment.

FIG. 8 is a diagram illustrating a backward analysis condition setting example that takes into account a device type in the first embodiment.

FIG. 9 is a diagram illustrating an example in which a ladder circuit related to a relevant part is displayed from dependency relation graph display in the first embodiment.

FIG. 10 is a flowchart illustrating extraction processing for dependency relations that takes into account a device type in the first embodiment.

FIG. 11 is a diagram illustrating a forward analysis condition setting example that takes into account a device type in the first embodiment.

FIG. 12 is a flowchart illustrating extraction processing for dependency relations that takes into account a device type in the first embodiment.

FIG. 13 is a diagram illustrating a forward analysis condition setting example that takes into account the number of times of reference in a second embodiment.

FIG. 14 is a diagram illustrating a forward dependency relation extraction result example that takes into account the number of times of reference in the second embodiment.

FIG. 15 is a flowchart illustrating extraction processing for dependency relations that takes into account the number of times of reference in the second embodiment.

FIG. 16 is a diagram illustrating an analysis-condition-setting operation unit in the second embodiment.

FIG. 17 is a diagram illustrating a use state extraction result in the second embodiment.

FIG. 18 is a diagram illustrating the configuration of a ladder program in a third embodiment.

FIG. 19 is a diagram illustrating a backward dependency relation extraction result in the third embodiment.

FIG. 20 is a diagram illustrating an analysis-condition-setting operation unit in the third embodiment.

FIG. 21 is a diagram illustrating a backward dependency relation extraction result that takes into account the number of times of control dependency in one ladder row in the third embodiment.

FIG. 22 is a flowchart illustrating extraction processing for dependency relations that takes into account the number of times of control dependency in one ladder row in the third embodiment.

FIG. 23 is a diagram illustrating self holding in a fourth embodiment.

FIG. 24 is a diagram illustrating a forward analysis condition setting example that takes into account a self-holding device in the fourth embodiment.

FIG. 25 is a flowchart illustrating extraction processing for dependency relations that takes into account the self-holding device in the fourth embodiment.

FIG. 26 is a flowchart illustrating extraction processing for automatically setting, as a new start point, an end point of obtained dependency relations in a fifth embodiment.

FIG. 27 is a diagram illustrating a forward dependency extraction result in the fifth embodiment.

FIG. 28 is a flowchart illustrating extraction processing for dependency relations that takes into account an A contact in a seventh embodiment.

FIG. 29 is a diagram illustrating an analysis-condition-setting operation unit in an eighth embodiment.

FIG. 30 is a diagram illustrating a device memory dump in the eighth embodiment.

FIG. 31 is a diagram illustrating the configuration of a ladder program in the eighth embodiment.

FIG. 32 is a diagram illustrating a backward dependency relation extraction result in the eighth embodiment.

FIG. 33 is a flowchart illustrating extraction processing for dependency relations that takes into account a device memory dump in the eighth embodiment.

FIG. 34 is a diagram illustrating a dependency relation extraction result in a ninth embodiment.

FIG. 35 is a diagram illustrating dependency relation display in the ninth embodiment.

FIG. 36 is a diagram illustrating a hardware configuration in a tenth embodiment.

FIG. 37 is a diagram illustrating an example in which dependency relations for specifying a cause are displayed from abnormality occurrence display in the tenth embodiment.

### DESCRIPTION OF EMBODIMENTS

Embodiments of a program analysis supporting device according to the present invention are explained in detail below based on the drawings. The present invention is not limited by the embodiments.

### First Embodiment

A program analysis supporting device 1 according to a first embodiment is explained.

The program analysis supporting device 1 is a device for improving efficiency of debug work for searching for a cause of occurrence of an operation deficiency of a developed new ladder program concerning a ladder program executed in various industrial controllers such as a programmable controller (hereinafter referred to as “PC”), a motion controller (hereinafter referred to as “MC”), a numerical control device controller (hereinafter referred to as “NC”), an inspection device controller, and a display (hereinafter referred to as “GOT”), a control device, or a micro computer. In the following explanation, the PC is described as an example.

The PC executes a ladder program (a measurement control program) and grasps a state of a measurement control target or instructs the measurement control target to perform an operation. For creation of the ladder program, a predetermined ladder program creation supporting device (measurement control program creation supporting device) is used. In general, the ladder program creation supporting device is provided as a software tool operating on a personal computer. The ladder program creation supporting device has a function for supporting editing of the ladder program, which is a program used when the PC measures or controls the measurement control target. Besides, the ladder program creation supporting device has a function for connecting a personal computer and the PC and transferring the edited ladder program to the PC, and monitoring a state of a value of a variable (hereinafter referred to as “device”) that changes according to the state of the measurement control target or execution of the ladder program.

The program editing function and the monitoring function provided by the ladder program creation supporting device are also mounted on the GOT. The editing of the ladder program and the monitoring of a state of a value of the device can also be performed from the GOT that is in an always-on connection state with the PC.

As a function for performing debugging whether a controller is correctly operating concerning the ladder program, a sampling trace function is known. The sampling trace function is a function for acquiring (sampling), at a fixed period (sampling period), data (trace data) indicating a state of a device designated at designated timing and storing the acquired trace data in a predetermined memory (sampling trace memory).

The device referred to therein indicates a memory address of a PC to which an input or an output between a measurement monitoring control target of the PC and the PC is allocated and indicates a memory address internally used by the PC. For example, in the PC, device characters are determined in advance according to data types, for example, a memory address to which an input is allocated is referred to as X device, a memory address to which an output is allocated is referred to as Y device, an internally-used bit data (an internal relay) is referred to as M device, a memory address used for communication is referred to as B device, and a memory address indicating occurrence of an error is referred to as F device. Addresses of the devices are hexadecimal representations concerning the X device, the Y device, the B device, and the like and are decimal representations concerning the M device, the F device, and the like.

Concerning devices suspected as a cause of a defective operation, if sampling trace is performed and contents of the devices are analyzed by, for example, being displayed as a timing chart, it is expected that the cause of the defective operation is specified. However, there is a limit in a memory size that can be subjected to the sampling trace at a time.

The inventor examined the sampling trace and found that there are two problems.

As a first problem, because there is a limit in the memory size that can be subjected to the sampling trace at a time, it is necessary to narrow down the devices suspected as the cause of the defective operation.

As a second problem, the sampling trace is sometimes performed for devices including a large number of devices (e.g., operations of the devices) not substantially directly contributing to specify a cause of a deficiency. For example, when it is desired to perform the sampling trace concerning a deficiency with low reproducibility, i.e., a defective operation unpredictable when it occurs, it is conceivable to take measures for increasing a sampling implementation time by extending a sampling period. However, if the sampling period is extended, it is likely that the sampling trace is performed for devices including a large number of devices not substantially directly contributing to specify a cause of a deficiency and a detailed operation analysis concerning a defective operation is difficult.

As a technology for solving the first problem, there is a slicing technology. That is, in a ladder program, (a directed graph of) dependency relations of devices (variables) are extracted.

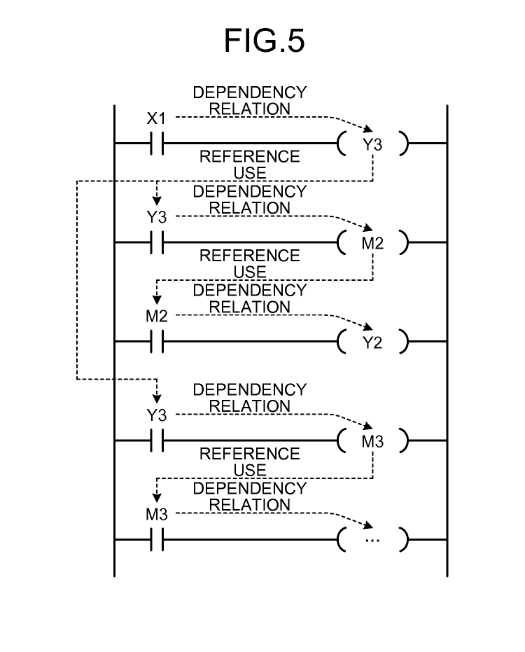

For example, the ladder program includes a plurality of ladder rows (see FIG. 5). The ladder program is configured to read each ladder row from the left to the right and read ladder rows from up to down. Calculation results of the ladder rows are sometimes stored in coil outputs and treated as inputs in following ladder rows (see FIG. 5). In other words, in the ladder program, processing is sequentially performed from the left to the right and from up to down.

A forward dependency relation is a relation for extracting other devices affected by a change in a value of a certain device and further extracting other devices affected by the devices to extract all devices affected by the change in the value of the certain device. That is, the forward dependency relation is a relation for tracing dependency relations along the direction of the sequential processing. A device group extracted in that way configures a directed graph (see FIG. 4).

A backward dependency relation is a relation for extracting other devices affecting a change in a value of a certain device and further extracting other devices affecting the devices to extract all devices affecting the change in the value of the certain device. That is, the backward dependency relation is a relation for tracing dependency relations in the opposite direction of the direction of the sequential processing. A device group extracted in that way configures a directed graph (see FIG. 4).

By using such (directed graph of) dependency relations of the devices, it is possible to narrow down devices suspended as a cause of a defective operation to some degree out of the ladder program.

However, in recent years, the ladder program is becoming larger and more complicated. Therefore, even if (the directed graph of) the dependency relations are used, it is difficult to narrow down the devices suspected as the cause of the defective operation to a required level. This is because, in the ladder program in recent years, the number of devices affected by a change in a value of a certain device is enormous or the number of devices affecting a change in a value of a certain device is enormous, (a directed graph of) extracted dependency relations are enormous and complicated, and it is highly likely that the devices cannot be substantially narrowed down to the required level only by using (the directed graph of) the dependency relations.

On the other hand, it is assumed that a large number of analysis conditions (an analysis command, an analysis target, etc.) are freely combined to perform a program analysis. In this case, it is also considered possible to extract only (a directed graph of) dependency relations more deeply matching the analysis conditions out of (a directed graph of) enormous and complicated dependency relations, i.e., narrow down the devices suspected as the cause of the defective operation to the required level by performing a large number of logical operations AND/OR/NOT of (a directed graph of) dependency relations.

On the other hand, debug work is performed using a production facility incorporating a PC. As explained above, the debug work is performed by connecting the personal computer and the PC. Besides, the debug work is performed using a display and an operation button included in the production facility.

To freely combine the large number of analysis conditions (the analysis command, the analysis target, etc.) to perform the program analysis, an advanced user interface for freely designating the large number of analysis conditions in combination is necessary. Therefore, when the personal computer and the PC are connected to perform the debug work, no problem occurs because the advanced user interface is realized by a keyboard, a mouse, and a high-resolution display or those of a touch panel type. However, when the debug work is performed using the display and the operation button included in the production facility, an operation method for freely designating the large number of analysis conditions in combination has to be realized within a limited range of these user interfaces. Therefore, it is likely that, compared with the case of the personal computer, the number of operations markedly increases and, all the worse, more labor and time are required.

That is, when the large number of analysis conditions (the analysis command, the analysis target, etc.) are freely combined to perform the program analysis, for example, if the debug work is performed using the display and the operation button included in the production facility, because the number of operations is markedly large, operation mistakes tend to be induced. Therefore, it is likely that the analysis conditions are not properly combined and it tends to be difficult to narrow down the devices suspected as the cause of the defective operation to the required level. As a result, the first problem is left unsolved.

Further, when the large number of analysis conditions (the analysis command, the analysis target, etc.) are freely combined to perform the program analysis, concerning a deficiency with low reproducibility, it is unpredictable when a defective operation occurs. Therefore, it is difficult to assume the large number of analysis conditions. That is, the second problem is also still unsolved.

Therefore, in the first embodiment, first, with the aim of solving the first problem, when the debug work is performed using the display and the operation button included in the production facility, a mechanism for selectively extracting (a directed graph of) dependency relations deeply related to a deficiency from (a directed graph of) enormous and complicated dependency relations with a small number of operations is proposed.

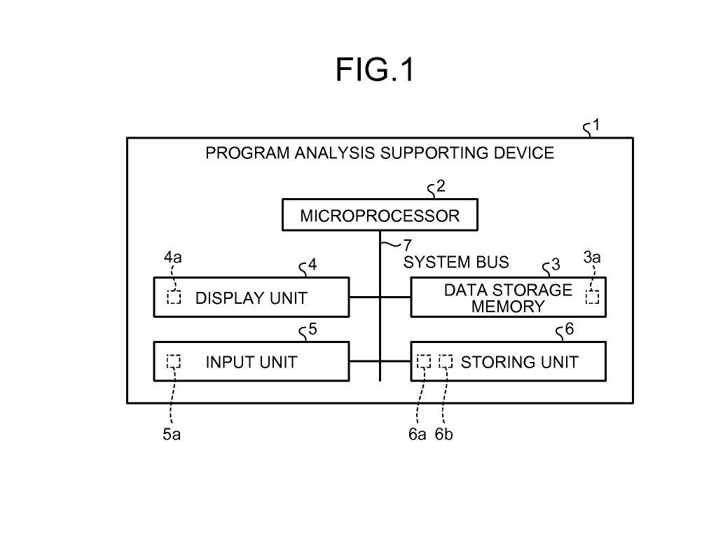

Specifically, the program analysis supporting device 1 includes a hardware configuration as shown in FIG. 1. FIG. 1 is a diagram illustrating the hardware configuration of the program analysis supporting device 1.

The program analysis supporting device 1 includes a microprocessor 2, a data storage memory 3, a display unit 4, an input unit 5, a storing unit 6, and a system bus 7. The microprocessor 2, the data storage memory 3, the display unit 4, the input unit 5, and the storing unit 6 are connected to one another via the system bus 7.

The microprocessor 2 comprehensively controls the units of the program analysis supporting device 1 and executes functions of the program analysis supporting device 1.

The data storage memory 3 temporarily stores data under the control by the microprocessor 2. The data storage memory 3 includes, for example, a work area 3a functioning as a work area by the microprocessor 2. The data storage memory 3 is configured by, for example, a DRAM (Dynamic Random Access Memory).

The display unit 4 displays predetermined information on a display screen 4a under the control by the microprocessor 2. The display unit 4 may be, for example, a display included in a production facility. The display includes, for example, a liquid crystal display. Alternatively, the display unit 4 may be, for example, a display device. The display device includes, for example, a liquid crystal display.

The input unit 5 receives a predetermined instruction from a user via an operation button 5a or the like. The operation button 5a is, for example, an operation button included in the production facility. The operation button 5a may be realized as, for example, a button object and a touch panel on the display screen 4a of the display included in the production facility. Alternatively, for example, the input unit 5 may be an input device including the operation button 5a and the like. The operation button 5a may be, for example, a physical button provided in an input device.

The storing unit 6 stores and retains programs such as a ladder program to be analyzed and a program for program analysis support 6a for realizing the functions of the program analysis supporting device 1 and data 6b such as an analysis result respectively as files. The storing unit 6 is configured by a storage device such as a hard disk.

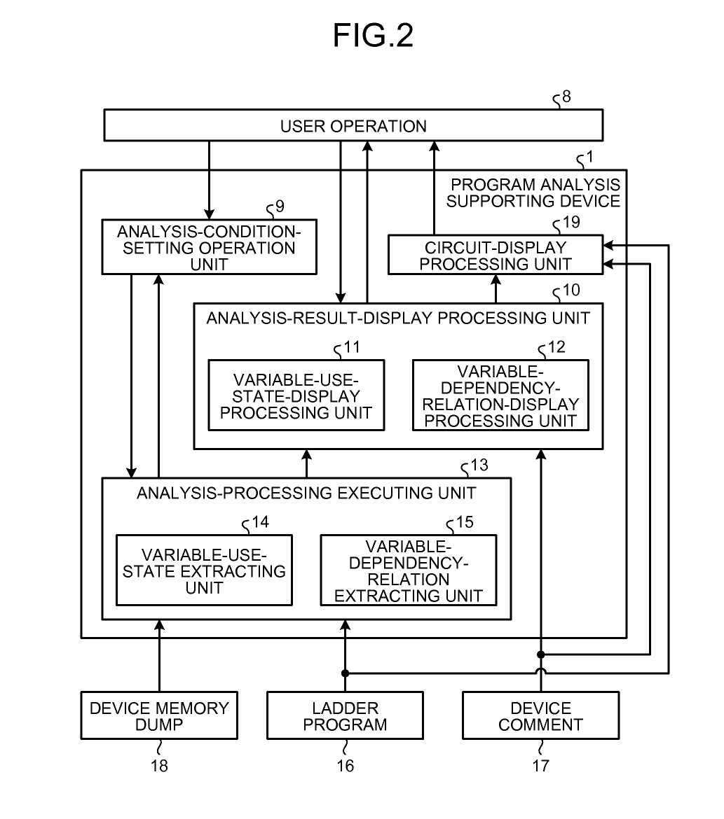

The program analysis supporting device 1 includes a functional configuration as shown in FIG. 2. FIG. 2 is a diagram illustrating the functional configuration of the program analysis supporting device 1.

For example, the program for program analysis support is executed by the microprocessor 2, whereby the functional configuration as shown in FIG. 2 is formed in the program analysis supporting device 1 (e.g., in the work area 3a in the data storage memory 3). The functional units of the program analysis supporting device 1 may be collectively formed according to the start of execution of the program for program analysis support or may be sequentially formed according to an execution state of the program for program analysis support.

Specifically, the program analysis supporting device 1 includes an analysis-condition-setting operation unit 9, an analysis-processing executing unit 13, an analysis-result-display processing unit 10, and a circuit-display processing unit 19.

When performing a program analysis for a ladder program 16, the user operates the operation button 5a or the like of the input unit 5 and performs user operation 8 for inputting a program analysis condition. The analysis-condition-setting operation unit 9 sets, according to an instruction corresponding to the user operation 8, a program analysis condition and supplies the program analysis condition to the analysis-processing executing unit 13.

For example, the analysis-condition-setting operation unit 9 generates, according to a start instruction received by the operation button 5a or the like in response to the user operation 8, a start command for the program for program analysis support and supplies the start command to the analysis-processing executing unit 13.

For example, the analysis-condition-setting operation unit 9 sets, according to a program setting instruction received by the operation button 5a or the like in response to the user operation 8, the ladder program 16 to be analyzed. The program setting instruction is an instruction for causing the analysis-condition-setting operation unit 9 to set the ladder program 16 to be analyzed. The analysis-condition-setting operation unit 9 supplies information concerning the set ladder program 16 to the analysis-processing executing unit 13.

For example, the analysis-condition-setting operation unit 9 sets, according to a start point setting instruction received by the operation button 5a or the like in response to the user operation 8, a start point of dependency relations desired to be extracted. The start point setting instruction is an instruction for causing the analysis-condition-setting operation unit 9 to set a start point of dependency relations desired to be extracted. The analysis-condition-setting operation unit 9 supplies information concerning the set start point of the dependency relations desired to be extracted to the analysis-processing executing unit 13.

The analysis-condition-setting operation unit 9 sets any one of a first condition and a second condition. The first condition is a condition related to a device, a further forward or backward device dependency relation of which is not to be extracted. The second condition is a condition related to a device, a further forward or backward device dependency relation of which is to be extracted. Details of the first condition and the second condition are explained below.

For example, the analysis-condition-setting operation unit 9 sets the first condition according to a first condition setting instruction received by the operation button 5a or the like in response to the user operation 8. The first condition setting instruction is an instruction for setting the first condition. The analysis-condition-setting operation unit 9 supplies information concerning the set first condition to the analysis-processing executing unit 13.

Alternatively, for example, the analysis-condition-setting operation unit 9 designates the second condition according to a second condition setting instruction received by the operation button 5a or the like in response to the user operation 8. The second condition setting instruction is an instruction for causing the analysis-condition-setting operation unit 9 to set the second condition. The analysis-condition-setting operation unit 9 supplies information concerning the set second condition to the analysis-processing executing unit 13.

The analysis-processing executing unit 13 receives a start command for the program for program analysis support from the analysis-condition-setting operation unit 9. The analysis-processing executing unit 13 reads, according to the start command for the program for program analysis support, the program for program analysis support stored in the storing unit 6.

The analysis-processing executing unit 13 receives a setting result of a program analysis condition from the analysis-condition-setting operation unit 9. The analysis-processing executing unit 13 executes program analysis processing according to the setting result of the program analysis condition and supplies a result of the program analysis processing, i.e., an analysis result to the analysis-result-display processing unit 10.

For example, the analysis-processing execution unit 13 includes a variable-use-state extracting unit 14 and a variable-dependency-relation extracting unit 15. For example, when instructed to extract use states via the analysis-condition-setting operation unit 9, the variable-use-state extracting unit 14 extracts use states of devices. The variable-use-state extracting unit 14 generates an extraction result of the use states of the devices and supplies the extraction result to the analysis-result-display processing unit 10.

For example, when instructed to extract a dependency relation via the analysis-condition-setting operation unit 9, the variable-dependency-relation extracting unit 15 extracts a dependency relation of a device. That is, the variable-dependency-relation extracting unit 15 extracts a forward or backward device dependency relation from the ladder program 16.

At this point, the variable-dependency-relation extracting unit 15 does not extract a further forward or backward device dependency relation concerning a device matching the first condition set via the analysis-condition-setting operation unit 9. The variable-dependency-relation extracting unit 15 extracts a further forward or backward device dependency relation concerning a device matching the second condition set via the analysis-condition-setting operation unit 9.

When extracting the device dependency relation, the variable-dependency-relation extracting unit 15 may take into account stored contents in a device memory dump 18.

The variable-dependency-relation extracting unit 15 generates an extraction result of the device dependency result, i.e., a first extraction result and supplies the first extraction result to the analysis-result-display processing unit 10.

The analysis-result-display processing unit 10 receives the result of the program analysis processing from the analysis-processing executing unit 13. The analysis-result-display processing unit 10 generates display information using the result of the program analysis processing and displays the result of the program analysis processing on the display screen 4a of the display unit 4 according to the generated display information.

For example, the analysis-result-display processing unit 10 includes a variable-use-state-display processing unit 11 and a variable-dependency-relation-display processing unit 12. For example, the variable-use-state-display processing unit 11 receives the extraction result of the use states of the devices from the variable-use-state extracting unit 14. The variable-use-state-display processing unit 11 generates display information using the extraction result of the use states of the devices and displays the extraction result of the use states of the devices on the display screen 4a of the display unit 4 according to the generated display information. For example, the variable-use-state-display processing unit 11 generates graph information obtained by summarizing the extraction result of the use states of the devices as a graph and displays the extraction result of the use states of the devices on the display screen 4a of the display unit 4 in a form of a graph according to the graph information. Consequently, the user viewing the display screen 4a can visually easily grasp the extraction result of the use states of the devices.

For example, the variable-dependency-relation-display processing unit 12 receives the extraction result of the device dependency relation, i.e., the first extraction result from the variable-use-state extracting unit 14. The variable-dependency-relation-display processing unit 12 converts the first extraction result into display information and displays the extraction result of the device dependency relation on the display screen 4a of the display unit 4 according to the converted display information. For example, the variable-dependency-relation-display processing unit 12 generates directed graph information obtained by summarizing the extraction result of the device dependency information as a directed graph (see FIGS. 4 and 7) and displays the extraction result of the device dependency relation on the display screen 4a of the display unit 4 in a form of a directed graph according to the directed graph information. Consequently, the user viewing the display screen 4a can visually easily grasp the extraction result of the device dependency relation.

For example, the variable-dependency-relation-display processing unit 12 designates a selected device according to a device selection instruction received by the operation button 5a or the like in response to the user operation 8. The device selection instruction is an instruction for designating, when one device is selected out of a device dependency relation (e.g., a directed graph) displayed on the display screen 4a by the variable-dependency-relation-display processing unit 12, the selected device. The variable-dependency-relation-display processing unit 12 supplies information concerning the designated device to the circuit-display processing unit 19.

The circuit display processing unit 19 receives the information concerning the designated device from the variable-dependency-relation-display processing unit 12. The circuit-display processing unit 19 generates display information on a ladder circuit according to the designated device. For example, the circuit-display processing unit 19 generates display information on a ladder circuit, which coil-outputs the designated device.

For example, the circuit-display processing unit 19 selectively displays the ladder circuit, which coil-outputs the designated device, instead of the device dependency relations (e.g., the directed graph) displayed by the variable-dependency-relation-display processing unit 12 (see the right figure in FIG. 9).

Alternatively, for example, the circuit-display processing unit 19 displays the ladder circuit, which coil-outputs the designated device, while displaying the entire device dependency relations displayed by the variable-dependency-relation-display processing unit 12, i.e., the extracted device dependency relations (e.g., the directed graph) (see FIG. 9). For example, the circuit-display processing unit 19 displays, side by side, the directed graph of the entire extracted device dependency relations and the ladder circuit, which coil-outputs the designated device (see FIG. 9). Alternatively, for example, the circuit-display processing unit 19 displays, while displaying the directed graph of the entire extracted device dependency relations, the ladder circuit, which coil-outputs the designated device, (e.g., in the center of the display screen 4a) such that the ladder circuit overlaps the directed graph.

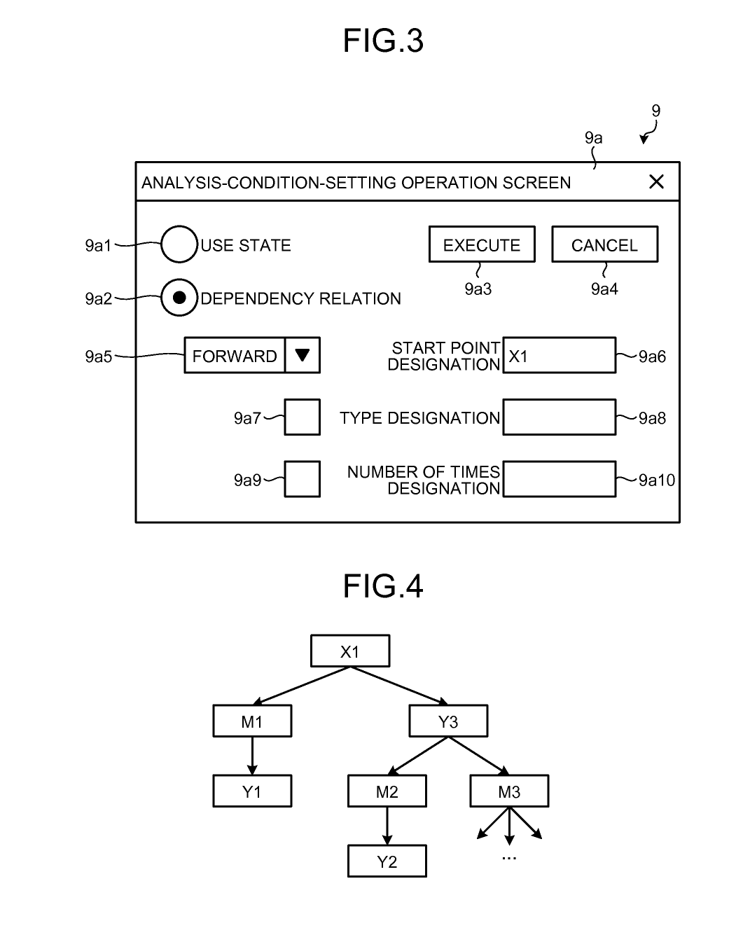

The configuration of the analysis-condition-setting operation unit 9 is explained using FIG. 3. FIG. 3 is a diagram illustrating the configuration of the analysis-condition-setting operation unit 9.

When the program for program analysis support is read by the analysis-processing executing unit 13 according to the start instruction received by the operation button 5a or the like in response to the user operation 8, the analysis-condition-setting operation unit 9 receives image data expanded by the analysis-processing executing unit 13. The analysis-condition-setting operation unit 9 displays, according to the screen data, for example, an analysis-condition-setting operation screen 9a as shown in FIG. 3 on the display screen 4a. The analysis-condition-setting operation unit 9 receives the user operation 8 via, for example, the analysis-condition-setting operation screen 9a.

For example, in FIG. 3, the program analysis supporting device 1 has a function for extracting use states of devices and a function for extracting dependency relations of the devices and the user selects and designates the function for extracting dependency relations of the devices. Further, in the case of the function for extracting dependency relations of the devices, the user designates whether a forward dependency relation is extracted or a backward dependency relation is extracted and designates a start point of analysis processing for the dependency relations. In FIG. 3, the user designates the forward dependency relation and designates an input device X1 as the start point.

Specifically, the analysis-condition-setting operation screen 9a includes analysis selection fields 9a1 and 9a2, an execution button 9a3, a cancel button 9a4, a direction designation field 9a5, a start point designation field 9a6, a type designation ON/OFF field 9a7, a type designation field 9a8, a number-of-times designation ON/OFF field 9a9, and a number-of-times designation field 9a10. Each of the analysis selection fields 9a1 and 9a2, the execution button 9a3, the cancel button 9a4, the direction designation field 9a5, the start point designation field 9a6, the type designation ON/OFF field 9a7, the type designation field 9a8, the number-of-times designation ON/OFF field 9a9, and the number-of-times designation field 9a10 is equivalent to the operation button 5a.

Any one of the two analysis selection fields 9a1 and 9a2 is alternatively selected. For example, when the analysis selection field 9a1 is selected, the analysis-condition-setting operation unit 9 selects extraction of use states of devices as analysis processing and notifies the variable-use-state extracting unit 14 of information indicating that the extraction of the use states of the devices is selected. According to the notification, for example, the variable-use-state extracting unit 14 recognizes that the variable-use-state extracting unit 14 is instructed via the analysis-condition-setting operation unit 9 to extract use states.

When the execution button 9a3 is pressed, the analysis-condition-setting operation unit 9 commands the variable-use-state extracting unit 14 to start the analysis processing. According to the command, the variable-use-state extracting unit 14 extracts use states of devices. The variable-use-state-display processing unit 11 displays display information (e.g., graph information) on the display screen 4a using a result of the extraction.

Alternatively, when the cancel button 9a4 is pressed, the analysis-condition-setting operation unit 9 commands the variable-use-state extracting unit 14 to cancel the analysis processing. According to the command, the variable-use-state extracting unit 14 stops the extraction of the use states of the devices.

Alternatively, for example, when the analysis selection field 9a2 is selected, extraction of a dependency relation of a device is selected as analysis processing. Information indicating that the extraction of the dependency relation of the device is selected is notified to the variable-dependency-relation extracting unit 15. According to the notification, for example, the variable-dependency-relation extracting unit 15 recognizes that the variable-dependency-relation extracting unit 15 is instructed via the analysis-condition-setting operation unit 9 to extract the dependency relation of the device.

In the direction designation field 9a5, any one of a forward direction and a backward direction is selected as the direction of a device dependency relation desired to be extracted. In FIG. 3, as an example, the forward direction is selected. In the direction designation field 9a5, for example, when a black triangle is clicked, the forward direction and the backward direction may be displayed as a pull-down menu and any one of the forward direction and the backward direction may be selected by being clicked.

In the start point designation field 9a6, a start point of dependency relations desired to be extracted is designated. In FIG. 3, as an example, the device X1 is designated as the start point of the dependency relations desired to be extracted.

In the type designation ON/OFF field 9a7, it is instructed whether type designation is performed (ON) or the type designation is not performed (OFF). In FIG. 3, as an example, it is instructed that the type designation is not performed (OFF). For example, the type designation ON/Off field 9a7 may be checked to instruct that the type designation is performed (ON) and may be unchecked to designate that the type designation is not performed (OFF).

In the type designation field 9a8, a first condition related to a device, a further forward or backward device dependency relation of which is not extracted, is instructed. For example, in the type designation field 9a8, as the first condition, a type of the device, a further forward or backward device dependency relation is not extracted, is instructed. The type of the device includes, for example, an X device indicating a device to which an input is allocated, a Y device indicating a device to which an output is allocated, an M device indicating internally-used bit data (an internal relay), a B device indicating a device used for communication, and an F device indicating occurrence of an error. In FIG. 3, as an example, the type designation field 9a8 is not designated.

When the execution button 9a3 is pressed, the analysis-condition-setting operation unit 9 commands the variable-dependency-relation extracting unit 15 to start analysis processing. According to the command, the variable-dependency-relation extracting unit 15 extracts a device dependency relation. The variable-dependency-relation-display processing unit 12 displays display information (e.g., directed graph information) on the display screen 4a using a result of the extraction, i.e., a first extraction result.

Alternatively, when the cancel button 9a4 is pressed, the analysis-condition-setting operation unit 9 commands the variable-dependency-relation extracting unit 15 to cancel the analysis processing. According to the command, the variable-dependency-relation extracting unit 15 stops the extraction of the device dependency relation.

The input device X1 designated as the start point may be configured to be designated by selecting a contact or a coil out of the ladder program displayed by the circuit-display processing unit 19.

FIG. 4 is an example of an execution result obtained when the analysis-condition-setting operation screen 9a is operated as shown in FIG. 3 and the execution button 9a3 is pressed. In FIG. 4, a large number of devices and dependency relations are extracted.

In this embodiment, taking notice of the fact that, as a cause of the extraction result becoming divergent in this way, the output device Y is sometimes referred to as a contact as shown in FIG. 5, whereby the number of devices extracted as dependency relations increases, for example, further extraction processing for dependency relations is not performed for a designated device type.

For example, because the Y device is an output device, originally, when a forward dependency relation is extracted starting from the input device X, an end point of the extraction is the Y device. Nevertheless, the extraction processing for dependency relations is advanced even to a degree in which the Y device is referred to as the contact. This exactly means that extraction of dependency relations starting from the Y device is further performed exceeding a range of extraction of dependency relations starting from the X device.

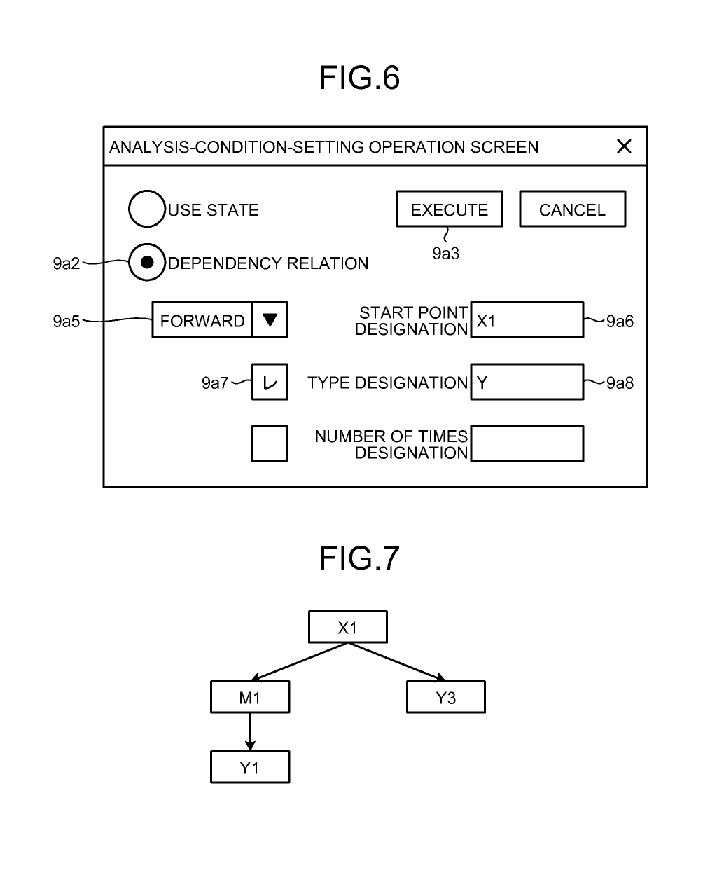

Therefore, in this embodiment, as shown in FIG. 6, for example, in order to suppress the extraction of dependency relations starting from the Y device, on the analysis-condition-setting operation screen 9a, a function for not performing further extraction processing for dependency relations according to a device type is checked and enabled to designate the Y device as a device type for which further extraction processing for dependency relations is not performed.

For example, as shown in FIG. 6, on the analysis-condition-setting operation screen 9a, the analysis selection field 9a2 of the two analysis selection fields 9a1 and 9a2 is selected, the forward direction is selected in the direction designation field 9a5, the device X1 is designated as a start point of dependency relations desired to be extracted in the start point designation field 9a6, and it is instructed in the type designation ON/OFF field 9a7 that type designation is performed (ON). In the type designation field 9a8, the Y device is designated as a type of a device, a further forward or backward device dependency relation of which is not extracted (a first condition).

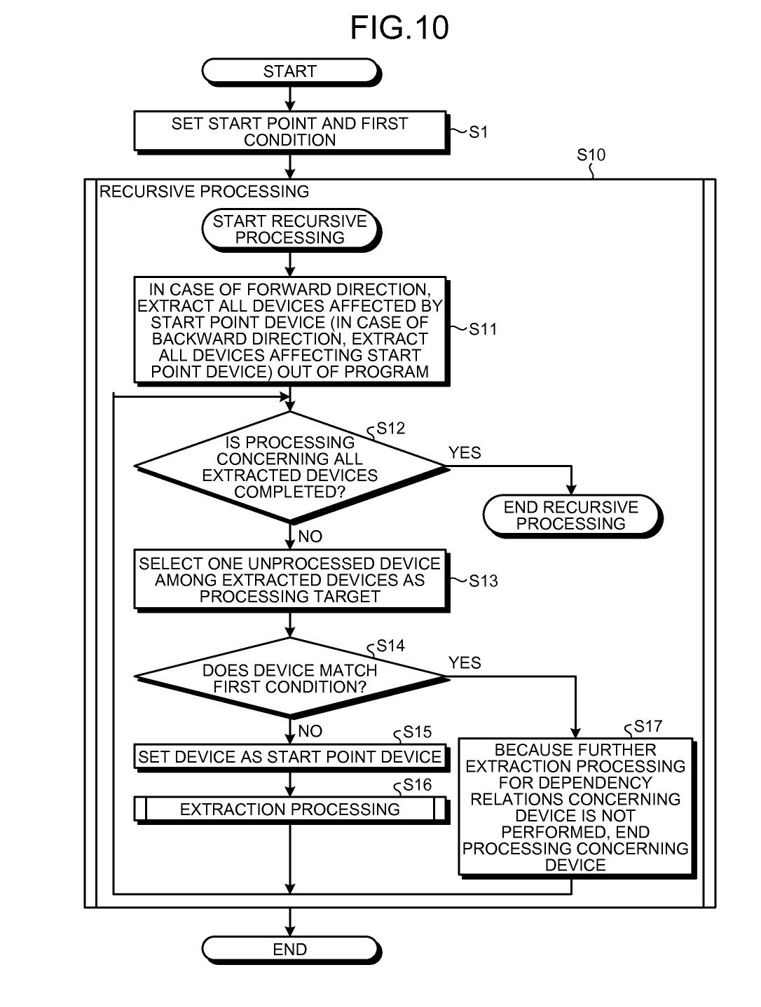

Extraction processing for dependency relations performed when the function for not performing further extraction processing for dependency relations according to a device type is checked and enabled is explained using FIG. 10. FIG. 10 is a flowchart illustrating the extraction processing for dependency relations that takes into account a device type.

In step S1, the analysis-condition-setting operation unit 9 sets, according to a start point setting instruction received by the operation button 5a or the like in response to the user operation 8, a start point of dependency relations desired to be extracted. For example, in the case shown in FIG. 6, the analysis-condition-setting operation unit 9 sets the device X1 as the start point of dependency relations desired to be extracted. The analysis-condition-setting operation unit 9 supplies information concerning the set start point of dependency relations desired to be extracted to the analysis-processing executing unit 13.

The analysis-condition-setting operation unit 9 sets the first condition according to a first condition setting instruction received by the operation button 5a or the like in response to the user operation 8. For example, in the case shown in FIG. 6, the analysis-condition-setting operation unit 9 sets the Y device as the first condition, i.e., the device type, a further forward or backward device dependency relation of which is not extracted. The analysis-condition-setting operation unit 9 supplies information concerning the set first condition to the analysis-processing executing unit 13.

In step S10, the variable-dependency-relation extracting unit 15 performs recursive processing. Specifically, the variable-dependency-relation extracting unit 15 performs processing of steps S11 to S17 explained below.

In step S11, the variable-dependency-relation extracting unit 15 extracts dependency relations of devices starting from a start point device (e.g., the device X1) set by the analysis-condition-setting operation unit 9. For example, when extraction of a forward device dependency relation is designated, the variable-dependency-relation extracting unit 15 extracts all devices affected by the start point device out of the ladder program 16. Alternatively, for example, when extraction of a backward device dependency relation is designated, the variable-dependency-relation extracting unit 15 extracts all devices affecting the start point device out of the ladder program 16.

In step S12, the variable-dependency-relation extracting unit 15 determines whether the processing in steps S13 to S17 is completed concerning all the extracted devices. When the processing is not completed (“No” in step S12), the variable-dependency-relation extracting unit 15 advances the processing to step S13. When the processing is completed (“Yes” in step S12), the variable-dependency-relation extracting unit 15 ends the processing.

In step S13, the variable-dependency-relation extracting unit 15 selects one of unprocessed devices among all the extracted devices as a processing target.

In step S14, the variable-dependency-relation extracting unit 15 determines whether the processing target device matches the first condition. For example, in the case shown in FIG. 6, the variable-dependency-relation extracting unit 15 determines whether the processing target device is a device type (e.g., the Y device), a further forward or backward device dependency relation of which is not extracted. When the processing target device matches the first condition (“Yes” in step S14), the variable-dependency-relation extracting unit 15 advances the processing to S17. When the processing target device does not match the first condition (“No” in step S14), the variable-dependency-relation extracting unit 15 advances the processing to S15.

In step S15, the variable-dependency-relation extracting unit 15 sets the processing target device as a start point anew.

In step S16, the variable-dependency-relation extracting unit 15 sets the start point set in step S15 as a second start point device and extracts dependency relations of devices. For example, when extraction of a forward device dependency relation is designated, the variable-dependency-relation extracting unit 15 extracts all devices affected by the second start point device out of the ladder program 16. Alternatively, for example, when extraction of a backward device dependency relation is designated, the variable-dependency-relation extracting unit 15 extracts all devices affecting the second start point device out of the ladder program 16. When the extraction processing is completed, the variable-dependency-relation extracting unit 15 returns the processing to step S12.

In step S17, because the variable-dependency-relation extracting unit 15 does not perform further extraction processing concerning dependency relations for the processing target device, the variable-dependency-relation extracting unit 15 ends the processing for the processing target device. The variable-dependency-relation extracting unit 15 returns the processing to step S12.

In this way, according to the extraction processing for dependency relations performed when the function for not performing further extraction processing for dependency relations according to a device type is checked and enabled, for example, a directed graph shown in FIG. 7 is displayed on the display screen 4a. FIG. 7 is a diagram illustrating a directed graph corresponding to a forward dependency relation extraction result example that takes into account a device type. The directed graph shown in FIG. 7 is obtained by, in a process for performing the processing for extracting forward dependency relations starting from the device X1, further advancing the extraction processing for dependency relations for a device M1, which is a device not matching the first condition and, when the processing reaches devices Y1, Y2, and Y3 (see FIG. 4), which are devices matching the first condition, not performing further extraction processing for dependency relations.

As is apparent from the fact that the directed graph shown in FIG. 4 is narrowed down like the directed graph shown in FIG. 7, by checking and enabling the function for not performing further extraction processing for dependency relations according to a device type, it is possible to narrow down (a directed graph of) enormous and complicated dependency relations without designating a large number of analysis conditions (an analysis command, an analysis target, etc.) in combination.

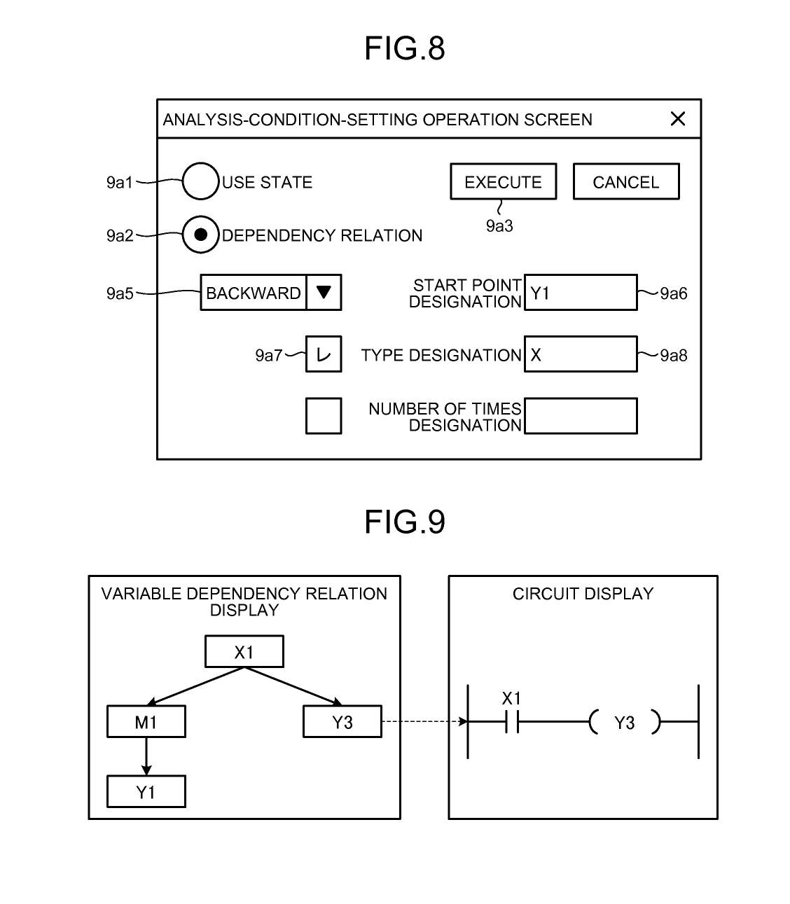

FIG. 6 illustrates, as an example, extraction of forward dependency relations. On the other hand, FIG. 8 illustrates, as an example, extraction of backward dependency relations. It is advisable to check and enable the function for not performing further extraction processing for dependency relations according to a device type and designate X as the device type for which further extraction processing for dependency relations is not performed.

For example, as shown in FIG. 8, on the analysis-condition-setting operation screen 9a, the analysis selection field 9a2 of the two analysis selection fields 9a1 and 9a2 is selected, the backward direction is selected in the direction designation field 9a5, the device Y1 is designated as a start point of dependency relations desired to be extracted in the start point designation field 9a6, and it is instructed in the type designation ON/OFF field 9a7 that type designation is performed (ON). In the type designation field 9a8, the X device is designated as a type of a device, a further forward or backward device dependency relation of which is not extracted (a first condition).

When the execution button 9a3 is pressed, the extraction processing for dependency relations is advanced and, when the extraction processing reaches the input X device, processing is performed not to perform further extraction processing for dependency relations. An effect is the same as the effect in the case of FIG. 6. For example, the directed graph shown in FIG. 4 can be narrowed down like the directed graph shown in FIG. 7.

As a device that is an input for the PC, there is not only the X device but also the B device or the like that is an input by communication. As a device that is an output for the PC, there is not only the Y device but also the B device that is an output by communication and the F device or the like that an error output. Therefore, for example, in the example shown in FIG. 6, the B device or the like may be designated as the start point device instead of the X device. As the device type for which further extraction processing for dependency relations is not performed, the B device, the F device, or the like may be designated instead of the Y device. Alternatively, for example, in the example shown in FIG. 8, the B device, the F device, or the like may be designated as the start point device instead of the Y device. As the device type for which further extraction processing for dependency relations is not performed, the B device or the like may be designated instead of the X device.

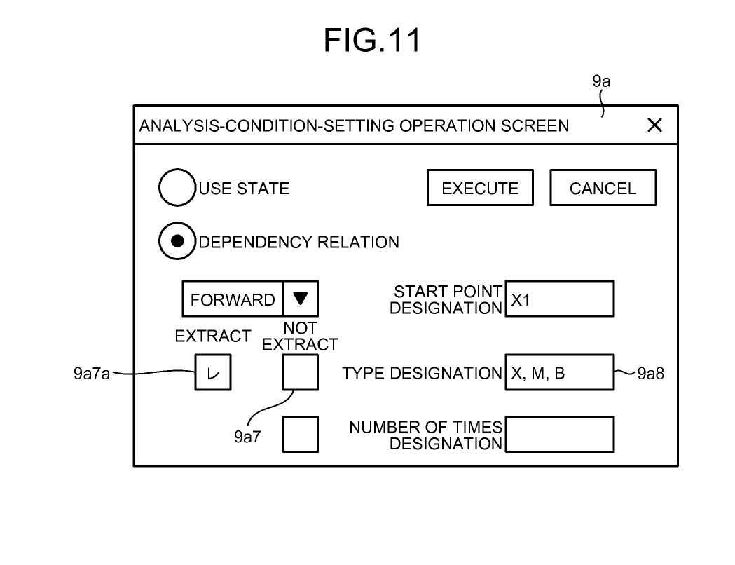

As shown in FIG. 11, the analysis-condition-setting operation screen 9a may further include a type designation ON/OFF field 9a7a. For example, both of the type designation ON/OFF field 9a7a and the type designation ON/OFF field 9a7 can be unselected. However, when selected, any one of the type designation ON/OFF field 9a7a and the type designation ON/OFF field 9a7 is alternatively selected. For example, when the type designation ON/OFF field 9a7 is selected (e.g., checked), it is selected to set a first condition related to a device, a further forward or backward device dependency relation of which is not extracted. Alternatively, for example, when the type designation ON/OFF field 9a7a is selected (e.g., checked), it is selected to set a second condition related to a device, a further forward or backward device dependency relation of which is extracted.

In this case, for example, in order to suppress extraction of dependency relations starting from the Y device, on the analysis-condition-setting operation screen 9a, as shown in FIG. 11, a function for performing further extraction processing of dependency relations according to a device type is checked and enabled and devices excluding the Y device are designated as the second condition, i.e., device types for which further extraction processing for dependency relations is performed. For example, in FIG. 11, the X device, the M device, and the B device are designated in the type designation field 9a8.

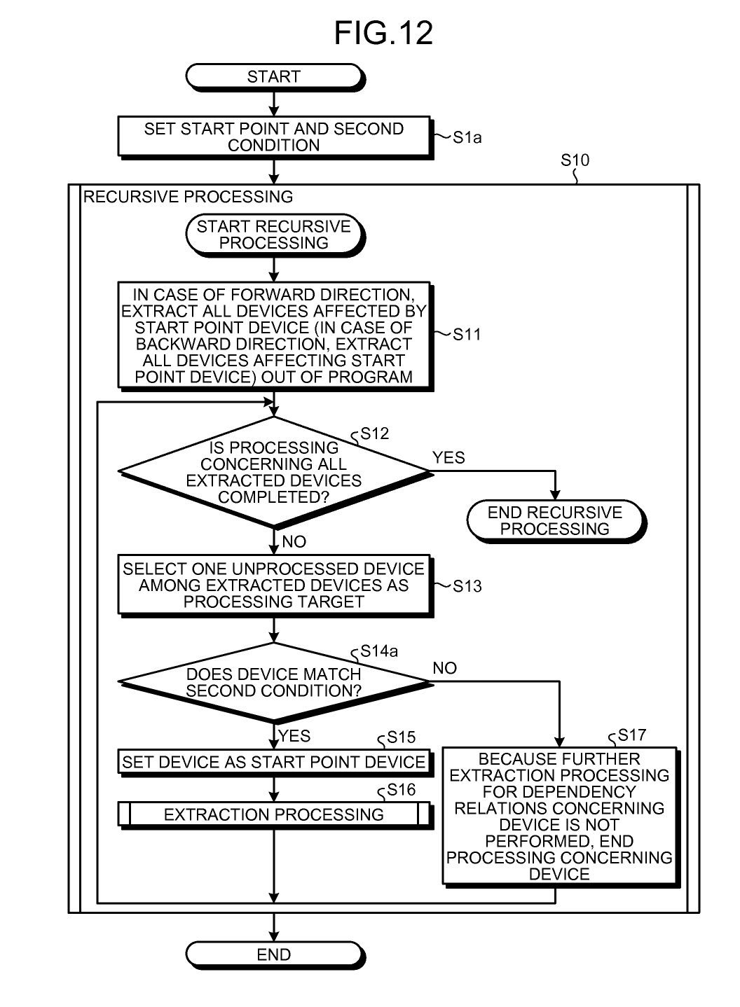

Extraction processing for dependency relations performed when the function for performing further extraction processing for dependency relations according to a device type is checked and enabled is explained using FIG. 12. The processing shown in FIG. 12 is different from the processing shown in FIG. 10 in points explained below.

In step S1a, the analysis-condition-setting operation unit 9 sets, according to a start point setting instruction received by the operation button 5a or the like in response to the user operation 8, a start point of dependency relations desired to be extracted. For example, in the case shown in FIG. 11, the analysis-condition-setting operation unit 9 sets the device X1 as a start point of dependency relations desired to be extracted. The analysis-condition-setting operation unit 9 supplies information concerning the set start point of the dependency relations desired to be extracted to the analysis-processing executing unit 13.

The analysis-condition-setting operation unit 9 sets a second condition according to a second condition setting instruction received by the operation button 5a or the like in response to the user operation 8. For example, in the case shown in FIG. 11, the analysis-condition-setting operation unit 9 sets the X device, the M device, and the B device as the second condition, i.e., device types, a further forward or backward device dependency relation of which is extracted. The analysis-condition-setting operation unit 9 supplies information concerning the set second condition to the analysis-processing executing unit 13.

In step S14a, the variable-dependency-relation extracting unit 15 determines whether the processing target device matches the second condition. For example, in the case shown in FIG. 11, the variable-dependency-relation extracting unit 15 determines whether the processing target device is the device type (e.g., the X device, the M device, or the B device), a further forward or backward device dependency relation of which is extracted. When the processing target device matches the second condition (“Yes” in step S14a), the variable-dependency-relation extracting unit 15 advances the processing to S15. When the processing target device does not match the second condition (“No” in step S14a), the variable-dependency-relation extracting unit 15 advances the processing to S17.

In this way, for example, the directed graph shown in FIG. 7 is also displayed on the display screen 4a by the extraction processing for dependency relations performed when the function for performing further extraction processing for dependency relations according to a device type is checked and enabled. The directed graph shown in FIG. 7 is obtained by, in a process for performing the processing for extracting forward dependency relations starting from the device X1, further advancing the extraction processing for dependency relations concerning the device M1, which is a device matching the second condition and, when the processing reaches the devices Y1, Y2, and Y3 (see FIG. 4), which are devices not matching the second condition, not performing further extraction processing for dependency relations.

If one device is selected out of (a directed graph of) the dependency relations extracted and displayed in this way, the variable-dependency-relation-display processing unit 12 may be configured to instruct the circuit-display processing unit 19 to display only a ladder circuit, which coil-outputs the selected device, or display, while displaying the entire device dependency relations conforming to the first extraction result, the ladder circuit, which coil-outputs the selected device. Then, a display configuration shown in FIG. 9 is obtained, which contributes to further improve the efficiency of analysis work. As (the directed graph of) the dependency relations, only dependency relations are extracted from a control structure of a ladder and other information is discarded to support grasping of the control structure of the ladder in a broader viewpoint. Therefore, for further efficiency of the analysis work, it is effective to not only display (the directed graph of) the dependency relations but also display, in order to locally check in detail a part, to which the user desires to direct attention, out of (the directed graph of) the dependency relations, a ladder circuit equivalent to that part.

When one device is selected out of (the directed graph of) the extracted and displayed dependency relations, the selected device may be displayed in a display form that can be distinguished from the other devices in (the directed graph of) the dependency relations. For example, as shown in FIG. 9, a broken line arrow may be displayed from the device Y3 to a displayed ladder circuit to display the device Y3 coil-output in the displayed ladder circuit and the device Y3 in (the directed graph of) the dependency relations conforming to the first extraction result in association with each other.

In the display of the ladder circuit, a device comment 17 (see FIG. 2) given to the device can be displayed together with the ladder circuit. Similarly, in the display of (the directed graph) of the dependency relations, the device comment 17 given to the device can be displayed together with (the directed graph) of the dependency relations.

As explained above, in the first embodiment, the analysis-condition-setting operation unit 9 sets the first condition related to a device, a further forward or backward device dependency relation of which is not extracted, or the second condition related to a device, a further forward or backward device dependency relation of which is extracted. The variable-dependency-relation extracting unit 15 extracts a forward or backward device dependency relation from the ladder program 16 starting from a start point set by the analysis-condition-setting operation unit 9 not to extract a further forward or backward device dependency relation concerning a device matching the first condition and to extract a further forward or backward device dependency relation concerning a device matching the second condition and generates a first extraction result. The variable-dependency-relation-display processing unit 12 displays device dependency relations according to the first extraction result. Consequently, by using the first condition or the second condition, it is possible to efficiently narrow down the device dependency relations using the directionality of the device dependency relations. As a result, it is possible to extract only (a directed graph of) dependency relations deeply related to a deficiency from (a directed graph of) enormous and complicated dependency relations without designating a large number of analysis conditions (an analysis command, an analysis target, etc.) in combination. That is, when debug work is performed using the display and the operation button included in the production facility, it is possible to extract, with a small number of operations, (a directed graph of) dependency relations deeply related to a deficiency from (a directed graph of) enormous and complicated dependency relations and display (the directed graph of) the dependency relations.

In the first embodiment, the analysis-condition-setting operation unit 9 sets, as the first condition, a device type (e.g., the Y device), a further forward or backward device dependency relation of which is not extracted. Alternatively, the analysis-condition-setting operation unit 9 sets, as the second condition, a device type, a further forward or backward device dependency relation of which is extracted. The variable-dependency-relation extracting unit 15 extracts a forward or backward device dependency relation from the ladder program 16 starting from a start point set by the analysis-condition-setting operation unit 9 not to extract a further forward or backward device dependency relation concerning a device matching the device type, a further forward or backward device dependency relation of which is not extracted, (the first condition) and to extract a further forward or backward device dependency relation concerning a device matching the device type, a further forward or backward device dependency relation of which is extracted, (the second condition) and generates a first extraction result. Consequently, by using the first condition or the second condition, it is possible to efficiently narrow down the device dependency relations using the directionality of the device dependency relations.

In the first embodiment, when one device is designated out of a device dependency relation conforming to the first extraction result, the circuit-display processing unit 19 selectively displays a ladder circuit, which coil-outputs the designated device. Alternatively, the circuit-display processing unit 19 selectively displays the ladder circuit, which coil-outputs the designated device, while displaying the entire device dependency relation conforming to the first extraction result. Consequently, it is possible to support grasping of a control structure of a ladder in a broader viewpoint using (a directed graph of) dependency relations and support local detailed checking of a part, to which the user desires to direct attention, out of (the directed graph of) the dependency relations. As a result, it is possible to further improve the efficiency of the analysis work.

### Second Embodiment

A program analysis supporting device according to a second embodiment is explained. In the following explanation, differences from the first embodiment are mainly explained.

A cause of enormous extracted devices and dependency relations is present aside from the cause explained in the first embodiment. The cause is the presence of the M device referred to as contacts in a large number of places. If such an M device is present, it is likely that (a directed graph of) dependency relations cannot be sufficiently narrowed down.

Therefore, in the second embodiment, a mechanism for taking measures when the M device referred to as contacts in a large number of places (referred to a large number of times) is present is explained.

The M device is internally used and is used for the purpose of temporarily storing a processing result. Therefore, a ladder creator determines for temporary storage of a processing result having what kind of characteristic the M device is used. However, the purpose of use of the M device is roughly divided into temporary storage of a mere processing result and storage of an internal state of a controller indispensable in performing measurement control of a target.

The M device for the temporary storage of a mere processing result is referred to as a contact a small number of times. On the other hand, the M device for storage of the internal state of the controller is referred to as a contact a markedly larger number of times. This is because, in the internal state of the controller, for example, a check of an interlock condition is extremely important in various measurement control functions.

That is, the M device that stores the internal state of the controller actually does not output a value of the internal state to the outside of the controller. However, the M device substantially plays a role equivalent to the Y device beyond a role of the temporary storage of a mere processing result. Therefore, as explained in the first embodiment, when the extraction processing for dependency relations is advanced even to a degree in which the M device is referred to as the contact, this exactly means that extraction of dependency relations starting from the M device is further performed exceeding an initial range of extraction of dependency relations starting from the M device.

Tanking notice of the above, in the second embodiment, further extraction processing for dependency relations is not performed concerning a device, the number of times of reference of which as the contact, i.e., the number of other devices affected by which is equal to or larger than a designated threshold. That is, the analysis-condition-setting operation unit 9 sets, as the first condition, (a threshold of) the number of times of reference including a start point device from the start point device.

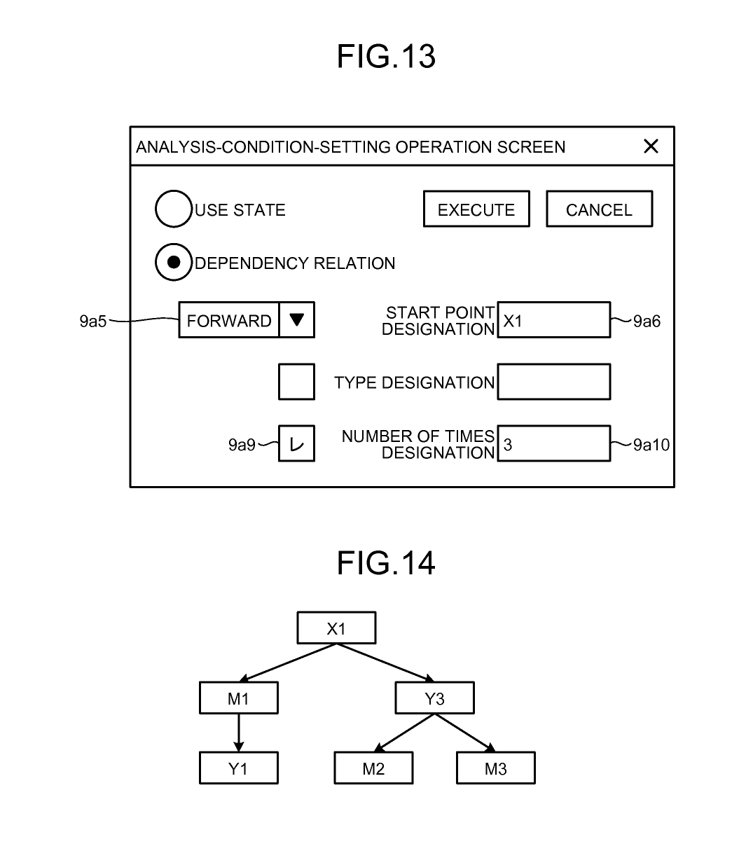

In FIG. 13, a function for not performing further extraction processing for dependency relations according to the number of times of reference is checked and enabled and three is designated as a threshold of the number of times of reference for not performing further extraction processing for dependency relations.

For example, in the number-of-times designation ON/OFF field 9a9, it is instructed whether designation of the number of times of reference is performed (ON) or the designation of the number of times of reference is not performed (OFF). In FIG. 13, as an example, it is instructed that the designation of the number of times of reference is performed (ON). In the number-of-times designation ON/OFF field 9a9, for example, by checking the number-of-times designation ON/OFF field 9a9, it may be instructed that the designation of the number of times of reference is performed (ON), and, by unchecking the number-of-times designation ON/OFF field 9a9, it may be instructed that the designation of the number of times of reference is not performed (OFF).

In the number-of-times designation field 9a10, a threshold of the number of times of reference of devices including a start point device from the start point device is designated. In FIG. 13, as an example, three is designated as the threshold of the number of times of reference. For example, when a forward direction is selected in the direction designation field 9a5, the device X1 is designated in the start point designation field 9a6, it is instructed in the number-of-times designation ON/OFF field 9a9 that the number of times of reference is designated (ON), and three (times) is designated in the number-of-times designation field 9a10, a further forward device dependency relation is not extracted if there is a device referred to three times or more among the devices including the device X1 when device dependency relations are traced in the forward direction starting from the device X1.

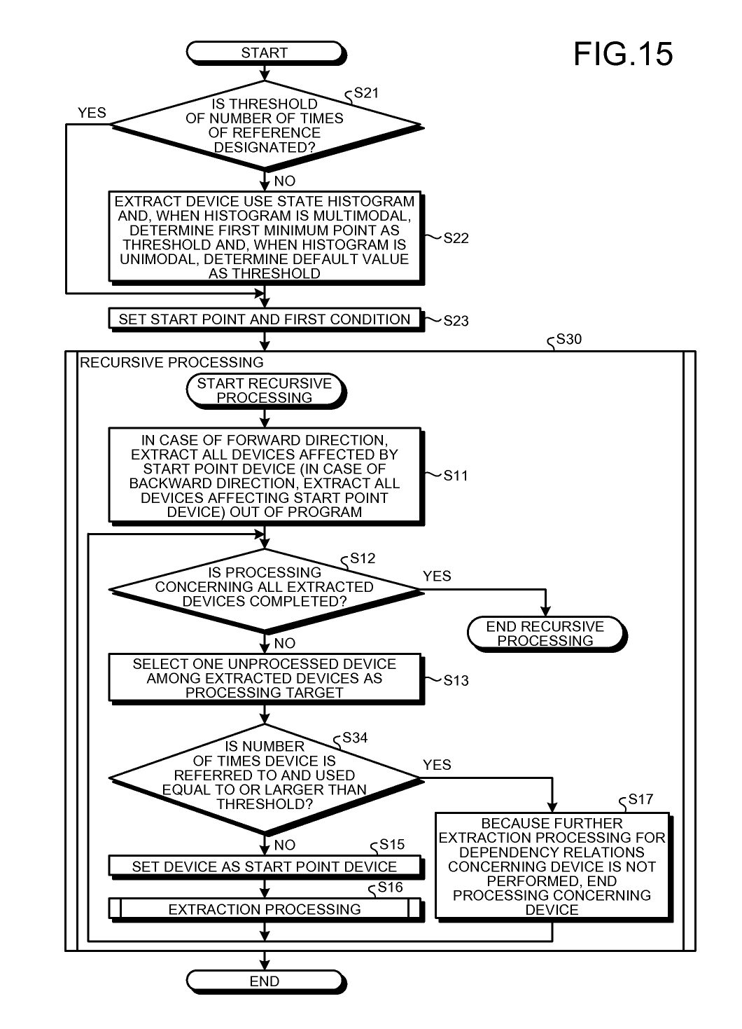

Extraction processing for dependency relations performed when a function for not performing further extraction processing for dependency relations according to the number of times of reference use of a device is checked and enabled is explained using FIG. 15. FIG. 15 is a flowchart illustrating the extraction processing for dependency relations that takes into account the number of times of reference.

In step S21, the analysis-condition-setting operation unit 9 determines whether a threshold of the number of times of reference is designated. When the threshold of the number of times of reference is designated (“Yes” in step S21), the analysis-condition-setting operation unit 9 advances the processing to step S23. When the threshold of the number of times of reference is not designated (“No” in S21), the analysis-condition-setting operation unit 9 advances the processing to step S22.

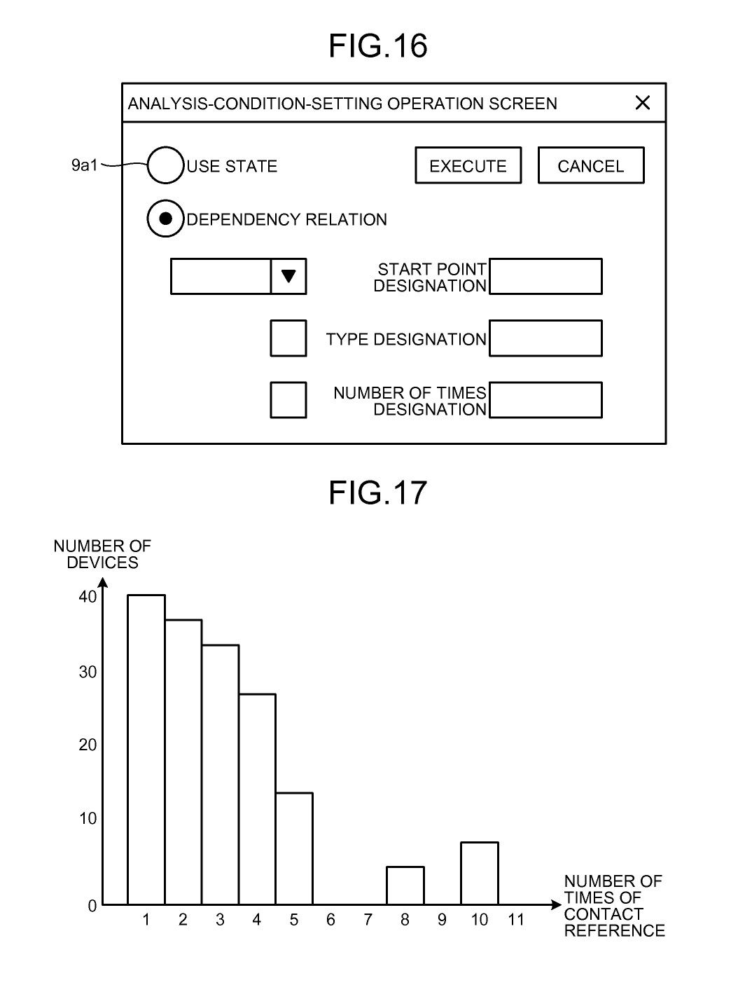

In step S22, the analysis-condition-setting operation unit 9 instructs the variable-use-state extracting unit 14 to extract a device use state histogram. For example, the variable-use-state extracting unit 14 recognizes that the variable-use-state extracting unit 14 is instructed via the analysis-condition-setting operation unit 9 to extract use states. For example, when the analysis selection field 9a1 is selected, the variable-use-state extracting unit 14 recognizes that the variable-use-state extracting unit 14 is instructed to extract use states (see FIG. 16). For example, when recognizing that the variable-use-state extracting unit 14 is instructed to extract use states, the variable-use-state extracting unit 14 extracts use states of devices. The variable-use-state extracting unit 14 generates an extraction result of the use states of the devices and supplies the extraction result to the variable-use-state-display processing unit 11.

For example, the variable-use-state-display processing unit 11 receives the extraction result of the use states of the devices from the variable-use-state extracting unit 14. The variable-use-state-display processing unit 11 generates display information using the extraction result of the use states of the devices and displays the extraction result of the use states of the devices on the display screen 4a of the display unit 4 according to the generated display information. For example, the variable-use-state-display processing unit 11 generates graph information obtained by summarizing the extraction result of the use states of the devices as a graph and displays the extraction result of the use states of the devices on the display screen 4a of the display unit 4 in a form of a graph according to the graph information.

For example, the variable-use-state-display processing unit 11 displays, using the extraction result of the use states of the devices, on the display screen 4a, a device use state histogram (see FIG. 17) in which the number of devices is plotted on the ordinate and the number of times of contact reference is plotted on the abscissa. Consequently, the user viewing the device use state histogram can determine a threshold of the number of times of reference according to a profile of the device use state histogram.

For example, when the profile of the device use state histogram is multimodal, the user can determine, as the threshold of the number of times of reference, the number of times of contact reference (e.g., in the case of FIG. 17, six) corresponding to a first minimum point. For example, when the profile of the device use state histogram is unimodal, the user can determine a default value (e.g., three) as the threshold of the number of times of reference.

The analysis-condition-setting operation unit 9 instructs, in response to the user operation 8, the variable-dependency-relation extracting unit 15 to perform extraction of device dependency relations. For example, the variable-dependency-relation extracting unit 15 recognizes that the variable-dependency-relation extracting unit 15 is instructed via the analysis-condition-setting operation unit 9 to extract device dependency relations. For example, when the analysis selection field 9a2 is selected, the variable-use-state extracting unit 14 recognizes that the variable-use-state extracting unit 14 is instructed to extract device dependency relations (see FIG. 13).

In step S23, the analysis-condition-setting operation unit 9 sets, according to a start point setting instruction received by the operation button 5a or the like in response to the user operation 8, a start point of dependency relations desired to be extracted. For example, in the case shown in FIG. 6, the analysis-condition-setting operation unit 9 sets the device X1 as the start point of the dependency relations desired to be extracted. The analysis-condition-setting operation unit 9 supplies information concerning the set start point of the dependency relations desired to be extracted to the analysis-processing executing unit 13.

The analysis-condition-setting operation unit 9 sets a first condition according to a first condition setting instruction received by the operation button 5a or the like in response to the user operation 8. For example, in the case shown in FIG. 13, the analysis-condition-setting operation unit 9 sets three as the first condition, i.e., a threshold of the number of times of reference for not extracting a further forward or backward device dependency relation. The analysis-condition-setting operation unit 9 supplies information concerning the set first condition to the analysis-processing executing unit 13.

In step S30, the variable-dependency-relation extracting unit 15 performs recursive processing. Specifically, the variable-dependency-relation extracting unit 15 performs processing that is basically the same as the recursive processing (step S10) in the first embodiment but different in the following points.

In step S34, the variable-dependency-relation extracting unit 15 determines whether the number of times a processing target device is referred to and used is equal to or larger than the threshold set in step S23. For example, in the case shown in FIG. 13, the variable-dependency-relation extracting unit 15 determines whether the number of times the processing target device is referred to and used is equal to or larger than three. When the number of times is equal to or larger than the threshold (“Yes” in step S34), the variable-dependency-relation extracting unit 15 advances the processing to S17. When the number of times is not equal to or larger than the threshold (“No” in step S34), the variable-dependency-relation extracting unit 15 advances the processing to step S15.

In this way, according to the extraction processing for dependency relations performed when the function for not performing further extraction processing for dependency relations according to the number of times of reference and use of a device is checked and enabled, for example, a directed graph shown in FIG. 14 is displayed on the display screen 4a. FIG. 14 is a diagram illustrating a directed graph corresponding to a forward dependency relation extraction result example that takes into account the number of times of reference. Because three is designated as the threshold, extraction processing for dependency relations is a further advanced concerning the devices M1 and Y3, which are devices referred to less than three times. Further extraction processing for dependency relations is not performed concerning devices M2 and M3 referred to three or more times.

The directed graph shown in FIG. 4 is narrowed down like the directed graph shown in FIG. 14. As is apparent from this, by checking and enabling the function for not performing further extraction processing for dependency relations according to the number of times of reference and use of a device, it is possible to narrow down (a directed graph of) enormous and complicated dependency relations without designating a large number of analysis conditions (an analysis command, an analysis target, etc.) in combination.

Concerning devices for which extraction of further dependency relations is stopped because the number of times of reference is equal to or larger than the threshold in display of extracted dependency relations, it is also possible to display the number of times of reference of each device together.

Actually, the number to be set as the threshold depends on a created ladder program. However, it is not easy even for a ladder creator himself or herself to appropriately set the threshold. Therefore, a function for extracting, as use states, the number of times of reference indicating to which degree devices are referred to and used as contacts, i.e., a histogram function for the number of times of contact reference of the devices is provided.

In FIG. 16, the function for extracting use states of devices is selected. In this case, setting of analysis conditions is not particularly necessary. FIG. 17 is an example of an execution result of the function. This histogram indicates that, for example, there are forty devices referred to as contacts once, i.e., used in one place as contacts in a program. In the example shown in FIG. 17, in a tendency that the number of devices having a large number of times of contact reference decreases, whereas there are no device referred to as a contact six times or seven times, there are several devices referred to as contacts eight times.

If such use states of devices are extracted with respect to a general ladder program, in many cases, a tendency is roughly like the tendency shown in FIG. 17, i.e., the shape of the histogram is multimodal rather than unimodal.

This corresponds to the fact that, whereas the purpose of use of the M device is roughly divided into temporary storage of a mere processing result and storage of an internal state of a controller indispensable in performing measurement control of a target, the M device that temporarily stores a mere processing result has a small number of times of contact reference but the number of such M devices tends to be large. This further corresponds to the fact that the M device that stores the internal state of the controller indispensable in performing measurement control of a target is referred to in various measurement control functions because, for example, a check of an interlock condition is extremely important and, therefore, the number of times of contact reference of the M device is large, and the number of such M devices is limited.

It is possible to determine, based on a result of the histogram of the number of times of contact reference obtained in this way, a value of the number of times of reference for not performing further extraction processing for dependency relations. Specifically, when the histogram of the number of times of contact reference as shown in FIG. 17 is obtained, as a threshold of the number of times of reference for not performing further extraction processing for dependency relations, for example, six corresponding to a first minimum point only can be designated. This is because, in the case of FIG. 17, six to seven as the number of times of contact reference is considered to be a threshold at a dividing point of the device that temporarily stores a mere processing result and the device that stores the internal state of the controller indispensable in performing measurement control of a target.

The program analysis supporting device may be configured to automatically perform the processing explained above. That is, the program analysis supporting device is configured to make it unnecessary for the user to explicitly extract device use states and find a threshold. For example, it is conceivable that the program analysis supporting device is configured to, when the user only checks the function for the number-of-times designation and does not input a threshold thereof, before performing the extraction processing for dependency relations, automatically extract device use states, extract a first minimum point from a histogram of the device use states, adopt the first minimum point as a threshold, and perform the extraction processing for dependency relations.

Consequently, it is possible to narrow down (a directed graph of) enormous and complicated dependency relations without designating a large number of analysis conditions (an analysis command, an analysis target, etc.) in combination.

In device types other than the M device, the number of times of reference sometimes becomes large. Therefore, the second embodiment can be applied without limiting the device type to the M device.

In the second embodiment, extraction of a backward dependency relation is the same as the extraction of the forward dependency relation. In particular, when the forward dependency relation is extracted, the effect of narrowing down dependency relations is large.

The first embodiment and the second embodiment can be implemented in combination. This enables further narrowing-down.

As explained above, in the second embodiment, the variable-use-state extracting unit 14 (see FIG. 2) extracts, from a ladder program, concerning devices, a histogram concerning the number of times the devices are referred to and used as contacts in a plurality of ladder rows to serve as reference information in setting a first condition (e.g. a threshold of the number of times of reference). Consequently, it is possible to specify, according to an extraction result of the histogram, a threshold of the number of times at a dividing point of a device that temporarily stores a mere processing result and a device that stores an internal state of a controller indispensable in performing measurement control of a target. It is possible to determine, as the first condition, for example, a threshold of the number of times of reference for not performing further extraction processing of dependency relations.

In the second embodiment, the analysis-condition-setting operation unit 9 sets, as the first condition, a threshold of the number of times of reference for not extracting a further forward or backward device dependency relation. The variable-dependency-relation extracting unit 15 extracts a forward or backward device dependency relation from the ladder program 16 starting from a start point set by the analysis-condition-setting operation unit 9 not to extract a further forward or backward device dependency relation concerning a device matching the threshold of the number of times of reference of devices, a further forward or backward device dependency relation of which is not extracted, (the first condition), i.e., the number of times of reference of which is equal to or larger than the threshold and generates a first extraction result. Consequently, by using the first condition, it is possible to efficiently narrow down the device dependency relations using the directionality of the device dependency relations.

### Third Embodiment

A program analysis supporting device according to a third embodiment is explained. In the following explanation, differences from the second embodiment are mainly explained.

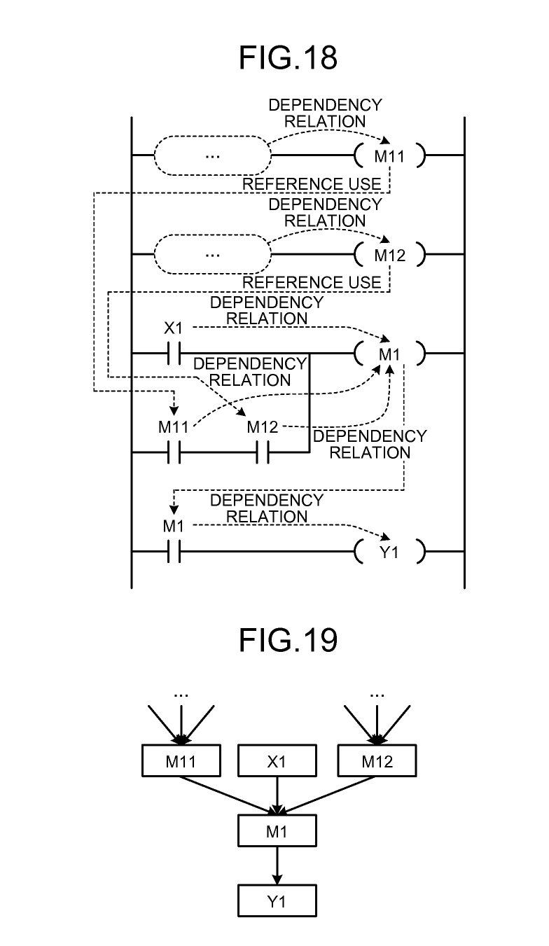

In the second embodiment, attention is directed to the M device referred to as contacts in a large number of places. Important one of the internally-used M devices is referred to as a contact many times. Besides, in some cases, the number of devices directly affecting the M device, i.e., the number of contacts that control a coil in one ladder row in which the M device is the coil is large. FIG. 18 is an example of such a ladder. It is seen that, if backward dependency relations are extracted with respect to such a ladder program, a directed graph as shown in FIG. 19 is obtained and an extraction result tends to be divergent.

Therefore, in the third embodiment, a mechanism for taking measures when the number of contacts that control a coil (the number of times of control dependence) is large in one ladder row in which the M device is the coil is explained.

The M device referred to as contacts many times in the second embodiment is important in terms of control that the M device stores an internal state of a controller. On the other hand, the M device with a large number of contacts that control the coil in the third embodiment is important in terms of the fact that a condition for controlling ON/OFF of the M device is extremely complicated and a deficiency tends to occur.

Taking notice of the above, in the third embodiment, further extraction processing for dependency relations is not performed concerning a device, the number of contacts of which in one ladder row, in which the device is a coil, i.e., the number of other devices directly affecting which exceeds a threshold of the number of times of control dependency. That is, the analysis-condition-setting operation unit 9 sets, as a first condition, (a threshold of) the number of times of control dependency indicating from how many contacts the control dependency is received in one ladder row.

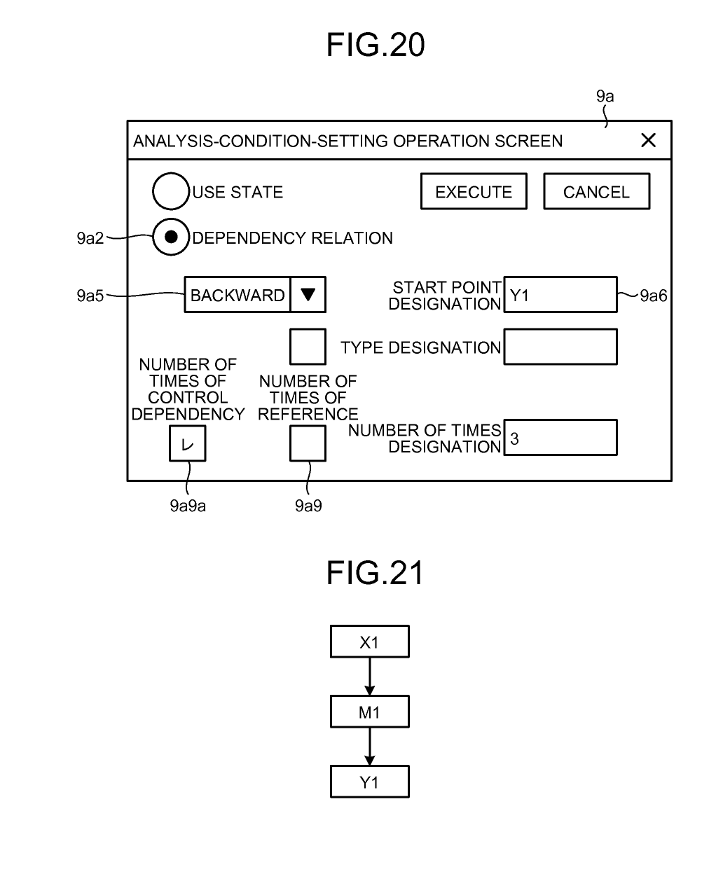

In FIG. 20, a function for not performing further extraction processing for dependency relations according to the number of times of control dependency indicating the number of contacts that control the coil in one ladder row is checked and enabled and three is designated as a threshold of the number of times of control dependency of the coil for not performing further extraction processing for dependency relations.

For example, the analysis-condition-setting operation screen 9a may further include a number-of-times designation ON/OFF field 9a9a. Both of the number-of-times designation ON/OFF field 9a9a and the number-of-times designation ON/OFF field 9a9 can be unselected. However, when selected, the number-of-times designation ON/OFF field 9a9a and the number-of-times designation ON/OFF field 9a9 are alternatively selected.

For example, in the number-of-times designation ON/OFF field 9a9a, it is instructed that designation of the number of times of control dependency is performed (ON) or the designation of the number of times of control dependency is not performed (OFF). In FIG. 20, as an example, it is instructed that the designation of the number of times of control dependency is performed (ON). For example, the number-of-times designation ON/OFF field 9a9a may be checked to instruct that the designation of the number of times of control dependency is performed (ON) and may be unchecked to instruct that the designation of the number of times of control dependency is not performed (OFF).

In the number-of-times designation field 9a10, a threshold of the number of times of control dependency indicating the number of contacts that control the coil in one ladder row is designated. In FIG. 20, as an example, three is designated as the threshold of the number of times of control dependency. For example, when the backward direction is selected in the direction designation field 9a5, the device Y1 is designated in the start point designation field 9a6, it is instructed in the number-of-times designation ON/OFF field 9a9a that designation of the number of times of control dependency is performed (ON), and three (times) is designated in the number-of-times designation field 9a10, a further backward device dependency relation is not extracted if a coil (e.g., devices M11 and M12 shown in FIG. 18) with the number of times of control dependency equal to or more than three in one ladder row occurs when device dependency relations are traced backward starting from the device Y1.

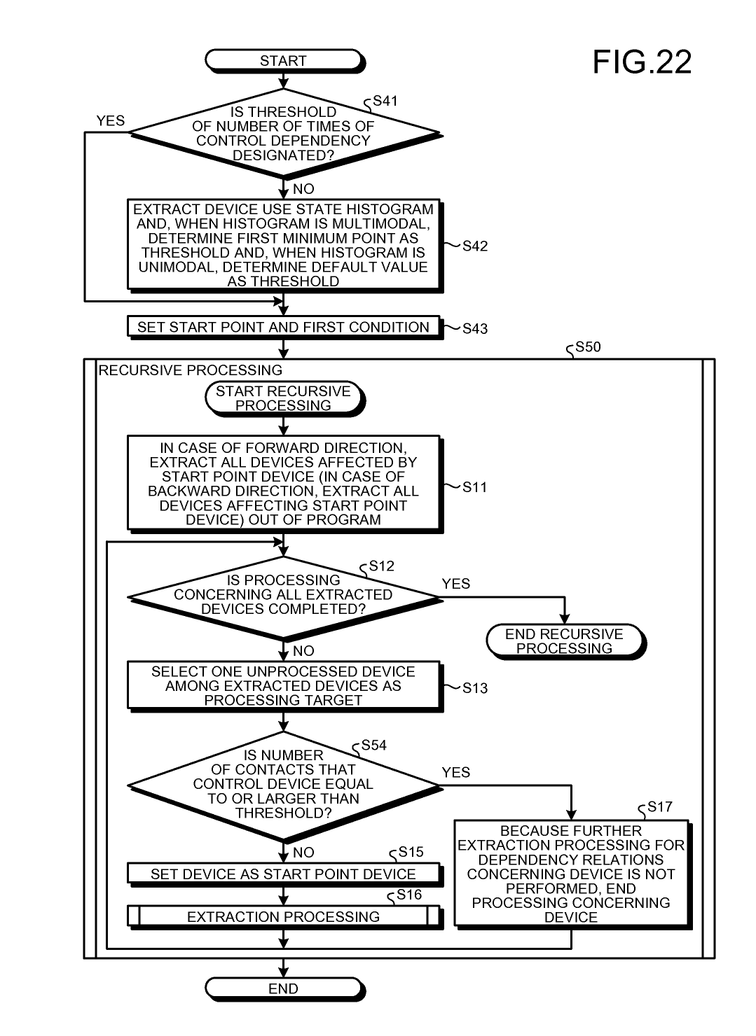

Extraction processing for dependency relations performed when a function for not performing further extraction processing for dependency relations according to the number of times of control dependency of a coil in one ladder row, in which a device is the coil, is checked and enabled is explained using FIG. 22. FIG. 22 is a flowchart illustrating the extraction processing for dependency relations that takes into account the number of times of control dependency.

In step S41, the analysis-condition-setting operation unit 9 determines whether a threshold of the number of times of control dependency is designated. When the threshold of the number of times of control dependency is designated (“Yes” in step S41), the analysis-condition-setting operation unit 9 advances the processing to step S43. When the threshold of the number of times of control dependency is not designated (“No” in step S41), the analysis-condition-setting operation unit 9 advances the processing to step S42.

In step S42, the analysis-condition-setting operation unit 9 instructs the variable-use-state extracting unit 14 to extract a device use state histogram. For example, the variable-use-state extracting unit 14 recognizes that the variable-use-state extracting unit 14 is instructed via the analysis-condition-setting operation unit 9 to extract use states. For example, when the analysis selection field 9a1 is selected, the variable-use-state extracting unit 14 recognizes that the variable-use-state extracting unit 14 is instructed to extract use states (see FIG. 16). For example, when recognizing that the variable-use-state extracting unit 14 is instructed to extract use states, the variable-use-state extracting unit 14 extracts use states of devices. The variable-use-state extracting unit 14 generates an extraction result of the use states of the devices and supplies the extraction result to the variable-use-state-display processing unit 11.

For example, the variable-use-state-display processing unit 11 receives the extraction result of the use states of the devices from the variable-use-state extracting unit 14. The variable-use-state-display processing unit 11 generates display information using the extraction result of the use states of the devices and displays the extraction result of the use states of the devices on the display screen 4a of the display unit 4 according to the generated display information. For example, the variable-use-state-display processing unit 11 generates graph information obtained by summarizing the extraction result of the use states of the devices as a graph and displays the extraction result of the use states of the devices on the display screen 4a of the display unit 4 in a form of a graph according to the graph information.

For example, the variable-use-state-display processing unit 11 displays, using the extraction result of the use states of the devices, on the display screen 4a, a device use state histogram (e.g., the number of times of contact reference on the abscissa is replaced by the number of times of control dependency in FIG. 17) in which the number of devices is plotted on the ordinate and the number of times of control dependency is plotted on the abscissa. Consequently, the user viewing the device use state histogram can determine a threshold of the number of times of control dependency according to a profile of the device use state histogram.

For example, when the profile of the device use state histogram is multimodal, the user can determine, as the threshold of the number of times of control dependency, the number of times of control dependency (e.g., six in the case where the number of times of contact reference on the abscissa is replaced by the number of times of control dependency in FIG. 17) corresponding to a first minimum point. For example, when the profile of the device use state histogram is unimodal, the user can determine a default value (e.g., three) as the threshold of the number of times of control dependency.

The analysis-condition-setting operation unit 9 instructs, in response to the user operation 8, the variable-dependency-relation extracting unit 15 to perform extraction of device dependency relations. For example, the variable-dependency-relation extracting unit 15 recognizes that the variable-dependency-relation extracting unit 15 is instructed via the analysis-condition-setting operation unit 9 to extract device dependency relations. For example, when the analysis selection field 9a2 is selected, the variable-use-state extracting unit 14 recognizes that the variable-use-state extracting unit 14 is instructed to extract device dependency relations (see FIG. 20).

In step S43, the analysis-condition-setting operation unit 9 sets, according to a start point setting instruction received by the operation button 5a or the like in response to the user operation 8, a start point of dependency relations desired to be extracted. For example, in the case shown in FIG. 20, the analysis-condition-setting operation unit 9 sets the device Y1 as the start point of the dependency relations desired to be extracted. The analysis-condition-setting operation unit 9 supplies information concerning the set start point of the dependency relations desired to be extracted to the analysis-processing executing unit 13.

The analysis-condition-setting operation unit 9 sets a first condition according to a first condition setting instruction received by the operation button 5a or the like in response to the user operation 8. For example, in the case shown in FIG. 20, the analysis-condition-setting operation unit 9 sets three as the first condition, i.e., a threshold of the number of times of control dependency for not extracting a further forward or backward device dependency relation. The analysis-condition-setting operation unit 9 supplies information concerning the set first condition to the analysis-processing executing unit 13.

In step S50, the variable-dependency-relation extracting unit 15 performs recursive processing. Specifically, the variable-dependency-relation extracting unit 15 performs processing that is basically the same as the recursive processing (step S10) in the first embodiment but different in the following points.

In step S54, the variable-dependency-relation extracting unit 15 determines whether the number of contacts that control a processing target result, i.e., the number of times of control dependency is equal to or larger than the threshold set in step S43. For example, in the case shown in FIG. 20, the variable-dependency-relation extracting unit 15 determines whether the number of times of control dependency is equal to or larger than three. When the number of times of control dependency is equal to or larger than the threshold (“Yes” in step S54), the variable-dependency-relation extracting unit 15 advances the processing to S17. When the number of times of control dependency is not equal to or larger than the threshold (“No” in step S54), the variable-dependency-relation extracting unit 15 advances the processing to step S15.

In this way, according to the extraction processing for dependency relations performed when the function for not performing further extraction processing for dependency relations according to the number of times of control dependency of a coil in one ladder row, in which a device is the coil, is checked and enabled, for example, a directed graph shown in FIG. 21 is displayed on the display screen 4a. FIG. 21 is a diagram illustrating a directed graph corresponding to a backward dependency relation extraction result example that takes into account the number of times of control dependency. Because three is designated as the threshold, further extraction processing for dependency relations is advanced concerning the device M1 with the number of times of control dependency smaller than three. Further extraction processing for dependency relations is not performed concerning the devices M11 and M12 (see FIG. 19) with the number of times of control dependency equal to or larger than three.

The directed graph shown in FIG. 19 is narrowed down like the directed graph shown in FIG. 21. As is apparent from this, by checking and enabling the function for not performing further extraction processing for dependency relations according to the number of times of control dependency of a coil in one ladder row in which a device is the coil, it is possible to narrow down (a directed graph of) enormous and complicated dependency relations without designating a large number of analysis conditions (an analysis command, an analysis target, etc.) in combination.

Concerning devices for which extraction of further dependency relations is stopped because the number of times of control dependency is equal to or larger than the threshold in display of extracted dependency relations, it is also possible to display the number of times of control dependency of each device together.

Actually, the number to be set as the threshold depends on a created ladder program as explained in the second embodiment. Therefore, a function for extracting, as use states, the number of contacts (the number of times of control dependency) indicating the number of contacts that control the devices (the number of times of control dependency) in one ladder row in which the devices are coils, i.e., a histogram function for the number of contacts (the number of times of control dependency) of the devices is provided. Contents and the like of the function are the same as those in the second embodiment.

In the third embodiment, extraction of a backward dependency relation is the same as the extraction of the forward dependency relation. In particular, when the backward dependency relation is extracted, the effect of narrowing down dependency relations is large.

The first to third embodiments can be implemented in combination as appropriate. For example, the first and third embodiments can be implemented in combination, the second and third embodiments can be implemented in combination, and the first, second, and third embodiments can be implemented in combination. This enables further narrowing-down.

As explained above, in the third embodiment, the variable-use-state extracting unit 14 (see FIG. 2) extracts, from the ladder program, concerning devices, a histogram concerning the number of times, which indicates from how many contacts the devices receive control dependency in one ladder row, to supply the histogram as reference information in setting a first condition (e.g. a threshold of the number of times of control dependency). Consequently, it is possible to specify, according to an extraction result of the histogram, a threshold at a dividing point of a device in which a condition for ON/OFF control is extremely complicated and a deficiency tends to occur and a device in which a condition for ON/OFF control is not so complicated and a deficiency less easily occurs. It is possible to determine, as the first condition, for example, a threshold of the number of times of control dependency for not performing further extraction processing of dependency relations.

In the third embodiment, the analysis-condition-setting operation unit 9 sets, as the first condition, a threshold of the number of times of control dependency for not extracting a further forward or backward device dependency relation. The variable-dependency-relation extracting unit 15 extracts a forward or backward device dependency relation from the ladder program 16 starting from a start point set by the analysis-condition-setting operation unit 9 not to extract a further forward or backward device dependency relation concerning a device matching the threshold of the number of times of control dependency for not extracting a further forward or backward device dependency relation (the first condition), i.e., the number of times of control dependency of which is equal to or larger than the threshold, and generates a first extraction result. Consequently, by using the first condition, it is possible to efficiently narrow down the device dependency relations using the directionality of the device dependency relations.

### Fourth Embodiment

A program analysis supporting device according to a fourth embodiment is explained. In the following explanation, differences from the second embodiment and the third embodiment are mainly explained.

Important one of the internally-used M devices as in the second and third embodiments is often self-holding.

Therefore, in the fourth embodiment, a mechanism for taking measures for the self-holding device is explained.

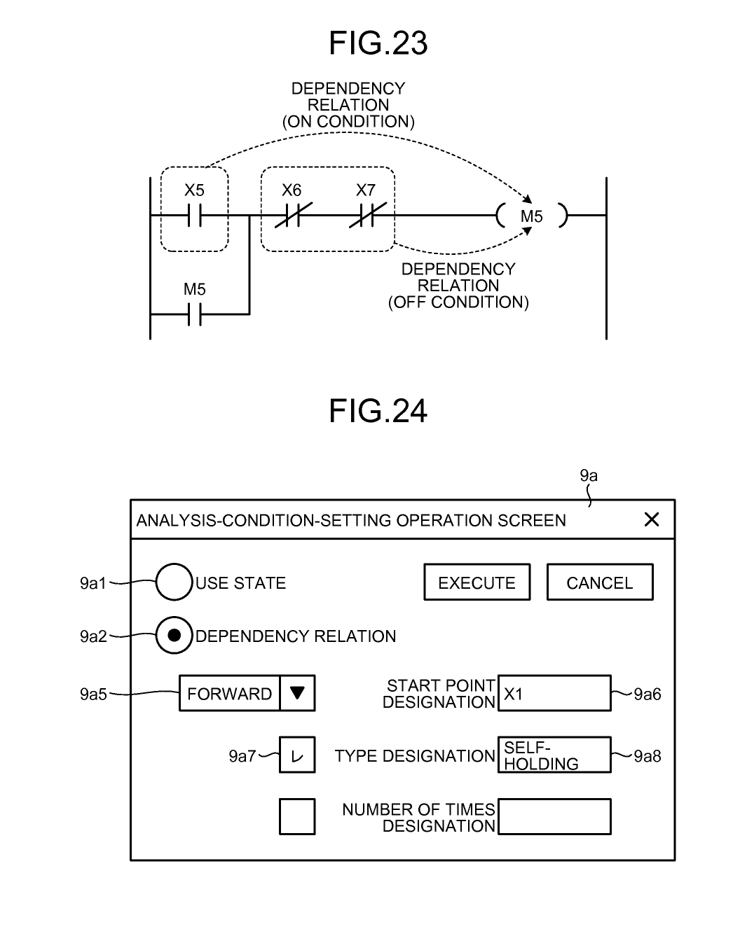

The self-holding means a ladder shown in FIG. 23. A device M5 is turned on when a device X5 is turned on and, even if the device X5 is turned off, the device M5 continues to hold on. Therefore, the device M5 is called self-holding. In order to turn off the device M5 continuing to hold on, a device X6 or a device X7 only has to be turned on. Therefore, for the device M5, a contact described in the position of the device X5 can be considered a dependency relation serving as an ON condition and a contact described in the position of the device X6 or the device X7 can be considered a dependency relation serving as an OFF condition.

In this way, the self-holding device holds a state. Therefore, the self-holding device often plays an important role in control.

Taking notice of the above, in the fourth embodiment, further extraction processing for dependency relations is not performed for a self-holding device that is used both as a contact and as a coil in one ladder row.

In FIG. 24, the function for not performing further extraction processing for dependency relations according to a device type is checked and enabled, and, as the device type for not performing further extraction for dependency relations, self-holding is designated.

For example, as shown in FIG. 24, on the analysis-condition-setting operation screen 9a, the analysis selection field 9a2 of the two analysis selection fields 9a1 and 9a2 is selected, the forward direction is selected in the direction designation field 9a5, the device X1 is designated in the start point designation field 9a6 as a start point of dependency relations desired to be extracted, and it is instructed in the type designation ON/OFF field 9a7 that type designation is performed (ON). In the type designation field 9a8, the self-holding device is designated as a type of a device, a further forward or backward device dependency relation of which is not extracted (a first condition).

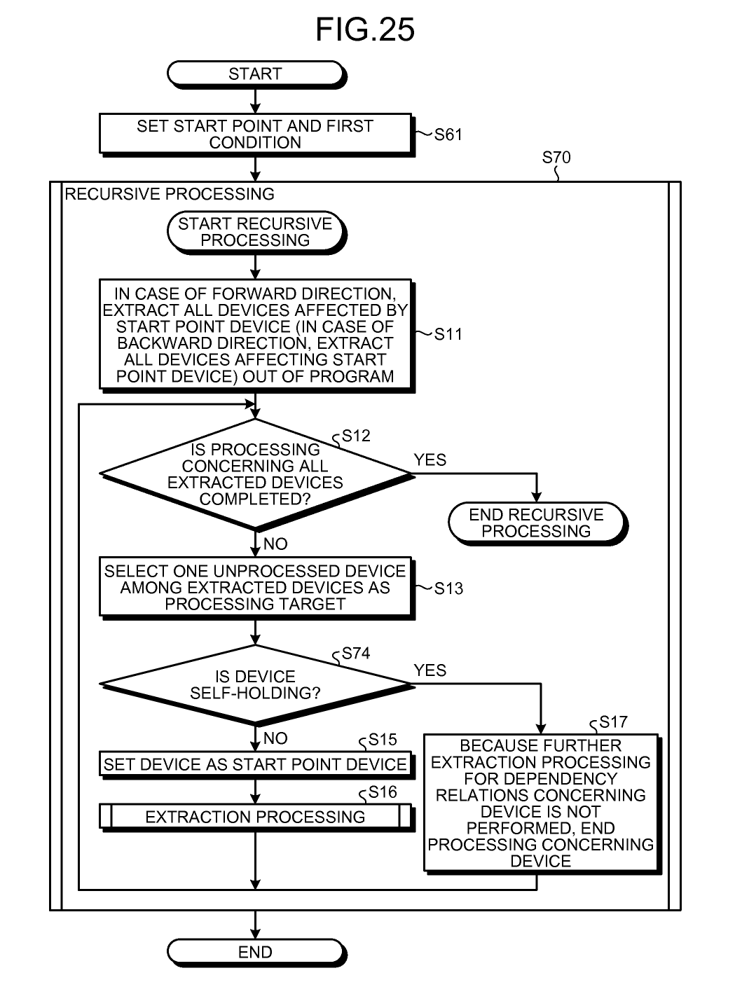

Extraction processing for dependency relations performed when the function for not performing further extraction processing for dependency relations according to a device type is checked and enabled is explained using FIG. 25. FIG. 25 is a flowchart illustrating the extraction processing for dependency relations that takes into account the self-holding device.

In step S61, the analysis-condition-setting operation unit 9 sets, according to a start point setting instruction received by the operation button 5a or the like in response to the user operation 8, a start point of dependency relations desired to be extracted. For example, in the case shown in FIG. 24, the analysis-condition-setting operation unit 9 sets the device X1 as the start point of dependency relations desired to be extracted. The analysis-condition-setting operation unit 9 supplies information concerning the set start point of dependency relations desired to be extracted to the analysis-processing executing unit 13.

The analysis-condition-setting operation unit 9 sets the first condition according to a first condition setting instruction received by the operation button 5a or the like in response to the user operation 8. For example, in the case shown in FIG. 24, the analysis-condition-setting operation unit 9 sets the self-holding device as the first condition, i.e., the device type, a further forward or backward device dependency relation of which is not extracted. The analysis-condition-setting operation unit 9 supplies information concerning the set first condition to the analysis-processing executing unit 13.

In step S70, the variable-dependency-relation extracting unit 15 performs recursive processing. Specifically, the variable-dependency-relation extracting unit 15 performs processing that is basically the same as the recursive processing in the first embodiment (step S10) but different in the following points.

In step S74, the variable-dependency-relation extracting unit 15 determines whether the processing target device is the self-holding device. When the processing target device is the self-holding device (“Yes” in step S74), the variable-dependency-relation extracting unit 15 advances the processing to S17. When the processing target device is not the self-holding device (“No” in step S74), the variable-dependency-relation extracting unit 15 advances the processing to S15.

In this way, according to the extraction processing for dependency relations performed when the function for not performing further extraction processing for dependency relations according to a device type is checked and enabled, it is possible to narrow down (a directed graph of) enormous and complicated dependency relations without designating a large number of analysis conditions (an analysis command, an analysis target, etc.) in combination.

In the fourth embodiment, extraction of a backward dependency relation is the same as the extraction of a forward dependency relation.

The first to fourth embodiments can be implemented in combination as appropriate. This enables further narrowing-down.

As explained above, in the fourth embodiment, the analysis-condition-setting operation unit 9 sets, as the first condition, a device type (e.g., the self-holding device), a further forward or backward device dependency relation of which is not extracted. The variable-dependency-relation extracting unit 15 extracts a forward or backward device dependency relation from the ladder program 16 starting from a start point set by the analysis-condition-setting operation unit 9 not to extract a further forward or backward device dependency relation concerning a device matching the device type, a further forward or backward device dependency relation of which is not extracted, (the first condition) and generates a first extraction result. Consequently, by using the first condition, it is possible to efficiently narrow down the device dependency relations using the directionality of the device dependency relations.

### Fifth Embodiment

A program analysis supporting device according to a fifth embodiment is explained. In the following explanation, differences from the first to fourth embodiments are mainly explained.

According to the first to fourth embodiments, although enormous and complicated dependency relations can be narrowed down, naturally, a dependency relation obtained as a result of the narrowing-down does not include all of devices affected by the start point device or devices affecting the start point device. This is because, whereas, in the conventional dependency relation extraction, further extraction of dependency relations is performed exceeding a range of extraction of dependency relations intended to be extracted, it is an object of the first to fourth embodiments to prevent such extraction.

Therefore, in the fifth embodiment, all of devices affected by the start point device or devices affecting the start point device are not extracted as one enormous and complicated dependency relation but are extracted as a set of a plurality of moderately narrowed-down dependency relations.

For example, when the device X1 is set as a start point for the ladder program shown in FIG. 5, whereas FIG. 4 is extracted in the conventional dependency relation extraction, in the first embodiment, devices are extracted as a result narrowed down as shown in FIG. 7. Further dependency relations can be separately extracted with the device Y3, which is one of the end points in FIG. 7 obtained in this way, as a new start point. Two dependency relations obtained in this way are equivalent to dependency relations obtained by dividing, with the device Y3, one dependency relation obtained without being narrowed down starting from the device X1.

In this way, checking a set of a plurality of moderately narrowed-down dependency relations is easier to understand than checking one enormous and complicated dependency relation. Moreover, these dependency relations are obtained by dividing one enormous and complicated dependency relation using a device having an important meaning in ladder processing. Therefore, the dependency relations are much easier to understand.

As a method for carrying out the above, further dependency relations are separately automatically extracted as new start points for end points of narrowed-down dependency relations. That is, further device dependency relations are separately extracted with end points in a device dependency relation, which is extracted in the same manner as in the first to fourth embodiments, set as new start points.

For example, the variable-dependency-relation extracting unit 14 separately extracts, for an end point device in a device dependency relation conforming to the first extraction result, a device dependency relation starting from the end point device and generates a second extraction result. The variable-dependency-relation extracting unit 14 supplies the generated second extraction result to the variable-dependency-relation-display processing unit 12.

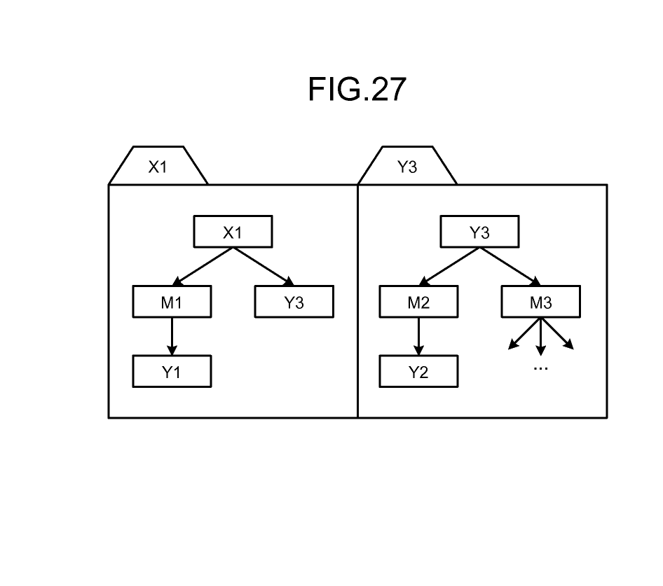

The variable-dependency-relation-display processing unit 12 receives the second extraction result from the variable-dependency-relation extracting unit 14. For example, the variable-dependency-relation-display processing unit 12 displays the device dependency relation according to the first extraction result and displays the device dependency relation according to the second extraction result. For example, the variable-dependency-relation-display processing unit 12 displays, on the display screen 4a, a directed graph of the device dependency relation conforming to the first extraction result and a directed graph of the device dependency relation conforming to the second extraction result in a form in which the directed graphs can be distinguished from each other (see FIG. 27). That is, the variable-dependency-relation-display processing unit 12 divides, based on the first extraction result and the second extraction result, the device dependency relation starting from the start point set by the analysis-condition-setting operation unit 9 (see FIG. 4) into two or more device dependency relations and displays the device dependency relations (see FIG. 27).

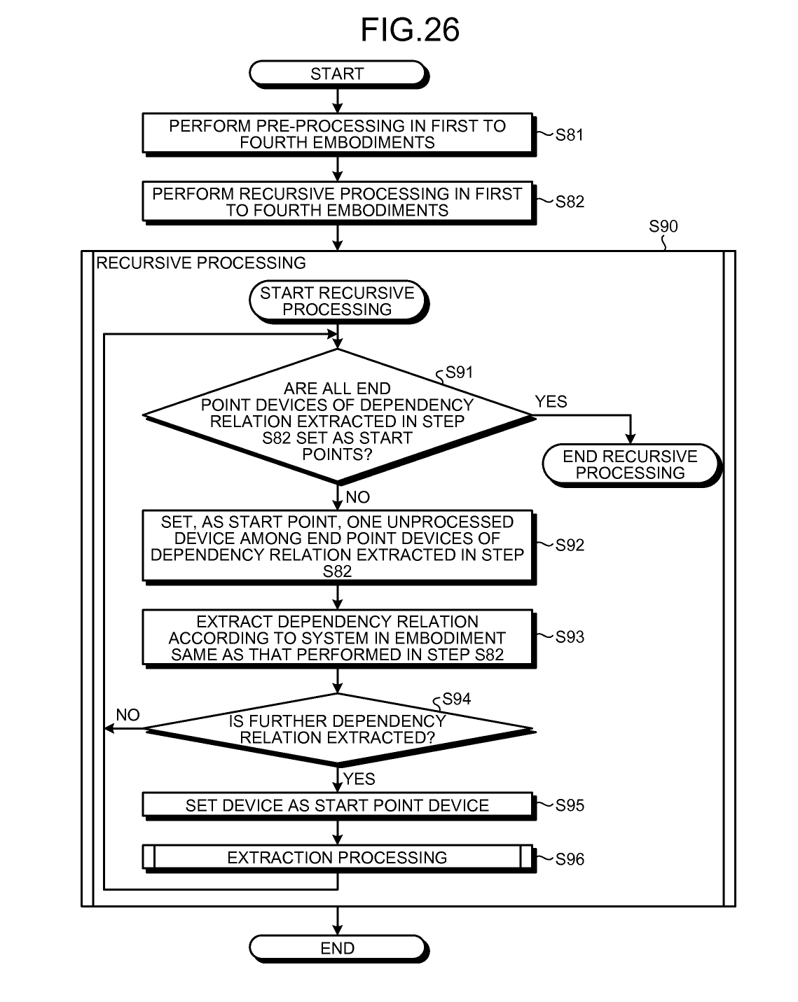

Processing for separately extracting further device dependency relations with end points in the device dependency relation, which is extracted in the same manner as in the first to fourth embodiments, set as new start points is explained using FIG. 26. FIG. 26 is a flowchart illustrating extraction processing for automatically setting an end point of an extracted dependency relation as a new start point.

In step S81, pre-processing same as that in the first to fourth embodiments is performed. For example, the analysis-condition-setting operation unit 9 performs processing same as step S1 in the first embodiment (see FIG. 10). Alternatively, for example, the analysis-condition-setting operation unit 9 and the variable-use-state extracting unit 14 perform processing same as steps S21 to S23 in the second embodiment (see FIG. 15). Alternatively, for example, the analysis-condition-setting operation unit 9 and the variable-use-state extracting unit 14 perform processing same as steps S41 to S43 in the third embodiment (see FIG. 22). Alternatively, for example, the analysis-condition-setting operation unit 9 performs processing same as step S61 in the fourth embodiment (see FIG. 25).

In step S82, the variable-dependency-relation extracting unit 15 performs recursive processing same as that in the first to fourth embodiment. For example, when the pre-processing in the first embodiment is performed in step S81, the variable-dependency-relation extracting unit 15 performs processing same as step S10 in the first embodiment (see FIG. 10). Alternatively, for example, when the pre-processing in the second embodiment is performed in step S81, the variable-dependency-relation extracting unit 15 performs processing same as step S30 in the second embodiment (see FIG. 15). Alternatively, for example, when the pre-processing in the third embodiment is performed in step S81, the variable-dependency-relation extracting unit 15 performs processing same as step S50 in the third embodiment (see FIG. 22). Alternatively, for example, when the pre-processing in the fourth embodiment is performed in step S81, the variable-dependency-relation extracting unit 15 performs processing same as step S70 in the fourth embodiment (see FIG. 25). Consequently, the variable-dependency-relation extracting unit 15 extracts a device dependency relation.

In step S90, the variable-dependency-relation extracting unit 15 performs recursive processing. Specifically, the variable-dependency-relation extracting unit 15 performs processing in steps S91 to S96 explained below.

In step S91, the variable-dependency-relation extracting unit 15 determines whether all end point devices in the device dependency relation extracted in step S82 are set as start points. When all the end point devices are set as start points (“Yes” in step S91), the variable-dependency-relation extracting unit 15 ends the processing. When not all the end point devices are set as start points (“No” in step S91), the variable-dependency-relation extracting unit 15 advances the processing to step S92.

In step S92, the variable-dependency-relation extracting unit 15 selects, as a processing target, one unprocessed device among all the end point devices in the device dependency relation extracted in step S82. The variable-dependency-relation extracting unit 15 sets the selected device as a start point anew.

In step S93, the variable-dependency-relation extracting unit 15 extracts a device dependency relation according to a system in the embodiment same as that performed in step S82.

In step S94, the variable-dependency-relation extracting unit 15 determines whether further extraction of dependency relations is performed in step S93. When the further extraction of dependency relations is performed (“Yes” in step S94), the variable-dependency-relation extracting unit 15 advances the processing to step S95. When the further extraction of dependency relations is not performed (“No” in step S94), the variable-dependency-relation extracting unit 15 returns the processing to step S91.

In step S95, the variable-dependency-relation extracting unit 15 sets the processing target device as a start point anew.

In step S96, the variable-dependency-relation extracting unit 15 extracts a dependency relation of devices with the start point set in step S95 set as a second start point device. For example, when extraction of a forward device dependency relation is designated, the variable-dependency-relation extracting unit 15 extracts all devices affected by the second start point device out of the ladder program 16. Alternatively, for example, when extraction of a backward device dependency relation is designated, the variable-dependency-relation extracting unit 15 extracts all devices affecting the second start point device out of the ladder program 16. When the extraction processing is completed, the variable-dependency-relation extracting unit 15 returns the processing to step S91.

According to this method, when the device X1 is set as a start point for the ladder program shown in FIG. 5, it is possible to extract dependency relations shown in FIG. 27. In FIG. 27, a directed graph of a device dependency relation extracted in the same manner as the first embodiment starting from the device X1 is shown together with a tab “X1”. For the end point device Y3 in the extracted device dependency relation, a directed graph of a device dependency relation starting from the end point device Y3 is separately shown together with a tab “Y3”.

Concerning devices matching the condition designated in the analysis-condition-setting operation unit 9, one device dependency relation obtained by being taken into account by the variable-dependency-relation display unit 12 without being narrowed down instead of being taken into account and narrowed down by the variable-dependency-relation extracting unit 15 may be divided into two or more device dependency relations and displayed based on the devices matching the designated condition. In this processing, the division processing for a device dependency relation processed by the variable-dependency-relation extracting unit 15 is only shifted to the variable-dependency-relation display unit 12. Therefore, substantial processing contents are the same.

As explained above, in the fifth embodiment, concerning an end point device in the device dependency relation conforming to the first extraction result, the variable-dependency-relation extracting unit 15 separately extracts a device dependency relation with the end point device set as a start point and generates a second extraction result. The variable-dependency-relation-display processing unit 12 divides, based on the first extraction result and the second extraction result, the device dependency relation starting from the start point set by the analysis-condition-setting operation unit 9 (see FIG. 4) into two or more device dependency relations and displays the device dependency relations (see FIG. 27). Consequently, it is possible to extract, in an easy-to-understand form, one enormous and complicated dependency relation as a set of moderately narrowed-down dependency relations obtained by dividing the one enormous and complicated dependency relation with a device having an important meaning in the ladder processing.

### Sixth Embodiment

A program analysis supporting device according to a sixth embodiment is explained. In the following explanation, differences from the second embodiment are mainly explained.

In the extraction of dependency relations in the second embodiment, dependency relations ahead of a device playing an important role in control are not extracted. That is, dependency relations between a start point device and the device playing an important role in control are extracted.

In order to generally grasp the entire control realized by a ladder program, it is efficient to check a dependency relation among devices playing an important role in the control.

Therefore, in the sixth embodiment, contrary to the second embodiment, dependency relations ahead of only devices with large number of times of reference are extracted. Dependency relations ahead of devices with small number of times of reference are not extracted.

For example, in the flowchart shown in FIG. 15, the processing in step S34 is replaced by processing in step S34a (not shown in the figure) explained below.

In step S34a, the variable-dependency-relation extracting unit 15 determines whether the number of times the processing target device is referred to and used is equal to or larger than the threshold set in step S23. For example, in the case shown in FIG. 13, the variable-dependency-relation extracting unit 15 determines whether the number of times the processing target device is referred to and used is three or more. When the number of times is equal to or larger than the threshold (“Yes” in step S34), the variable-dependency-relation extracting unit 15 advances the processing to S15. When the number of times is not equal to or larger than the threshold (“No” in step S34), the variable-dependency-relation extracting unit 15 advances the processing to S17.

Consequently, by extracting only a dependency relation among devices with larger number of times of reference and playing an important role in the control and omitting devices with small number of times of reference and playing accompanying and auxiliary roles in the control, it is possible to generally grasp the entire control realized by the ladder program.

The first to fifth embodiments can be implemented in combination as appropriate, which is more effective. For example, in a combination with the second embodiment, first, by using the second embodiment, a dependency relation between a start point device with a small number of times of reference and playing an accompanying and auxiliary role in the control and a device playing an important role in the control is extracted. Thereafter, an important device found in that way is automatically set as a start point according to the fifth embodiment. A dependency relation for enabling the entire control realized by the ladder to be generally grasped is extracted according to the sixth embodiment. Finally, the conventional dependency relation is extracted starting from a device most likely to be considered a cause of a deficiency out of the dependency relation. Consequently, it is possible to find a cause at a terminal end while avoiding a result in which dependency relations uselessly diverge.

### Seventh Embodiment

A program analysis supporting device according to a seventh embodiment is explained. In the following explanation, differences from the first to fourth embodiments are mainly explained.

In the first to fourth embodiments, although enormous and complicated dependency relations can be narrowed down, naturally, a dependency relation obtained as a result of the narrowing-down does not include all of devices affected by the start point device or devices affecting the start point device. This is because, whereas, in the conventional dependency relation extraction, further extraction of dependency relations is performed exceeding a range of extraction of dependency relations intended to be extracted, it is an object of the first to fourth embodiments to prevent such extraction.

As a defective operation that occurs in a production facility, there is a defective operation in which, although an input is turned on, an output is not turned on. In order to analyze a cause of the defective operation, in some cases, it is satisfactory to extract only devices that are turned on when a start point is turned on even if not all devices affected by a start point device are extracted.

Taking notice of the above, in the seventh embodiment, extraction processing for dependency relations is advanced only for a part used as an “a” contact. The “a” contact is, for example, a contact referred to in a positive logic such as the device X5 and a device M5 shown in FIG. 23. When the contact is turned on, a coil is turned on.

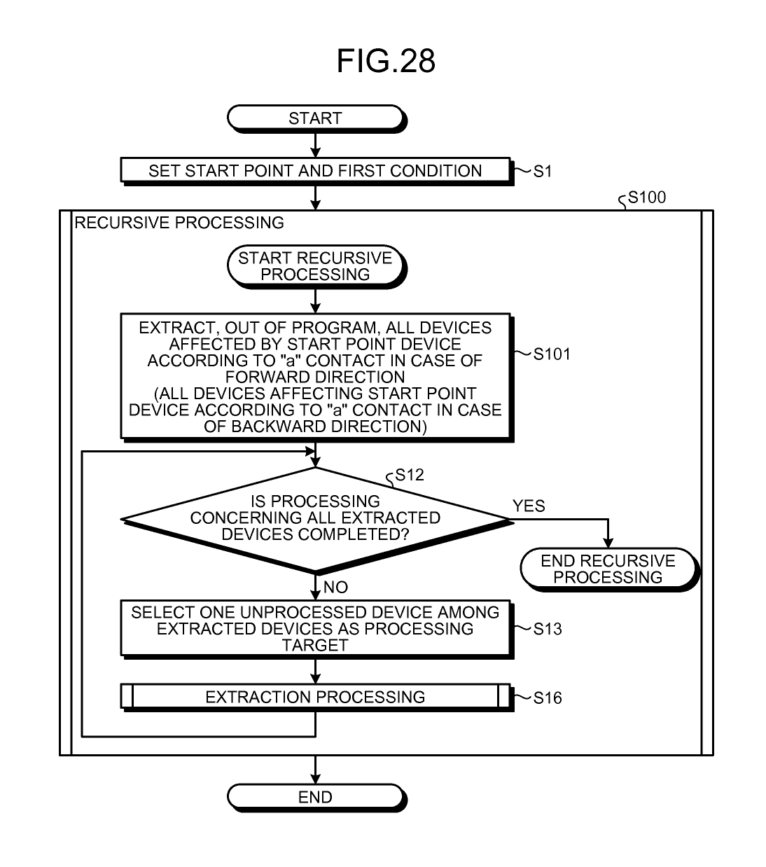

The extraction processing for dependency relations for only the part used as the “a” contact is explained using FIG. 28. FIG. 28 is a flowchart illustrating the extraction processing for dependency relations that takes into account the “a” contact.

In step S100, the variable-dependency-relation extracting unit 15 performs recursive processing. Specifically, the variable-dependency-relation extracting unit 15 performs processing that is basically the same as the recursive processing in the first embodiment (step S10) but different in the following points.

In step S101, the variable-dependency-relation extracting unit 15 extracts a dependency relation of devices starting from the start point device (e.g., the device X1) set by the analysis-condition-setting operation unit 9. For example, when extraction of a forward device dependency relation is designated, the variable-dependency-relation extracting unit 15 extracts all devices affected by the start point device according to the “a” contact out of the ladder program 16. Alternatively, for example, when extraction of a backward device dependency relation is designated, the variable-dependency-relation extracting unit 15 extracts all devices affecting the start point device according to the “a” contact out of the ladder program 16.

In this way, for example, according to the extraction processing for dependency relations limited to the part used as the “a” contact, it is possible to selectively extract a device turned on when the start point is turned on. That is, it is possible to narrow down (a directed graph of) enormous and complicated dependency relations without designating a large number of analysis conditions (an analysis command, an analysis target, etc.) in combination.

When an input is a negative logic, because the point to be referred to is a “b” contact instead of the “a” contact, in the same manner as explained above, the extraction processing for dependency relations is advanced only for a part used as the “b” contact. The “b” contact means a contact referred to in the negative logic such as the device X6 and the device X7 in FIG. 23. When the contact is turned off, a coil is turned on.

The forward dependency relation is explained above. In order to analyze why an output is not turned on, in some cases, it is satisfactory to selectively extract only devices that should be turned on, which is a condition for turning on a start point, even if not all devices affecting a start point device according to the “a” contact are extracted. Therefore, in the case of the backward dependency relation, in the same manner as explained above, the extraction processing for dependency relations is advanced only for a part used as the “a” contact. Because the logic is inverted between the “a” contact and the contact, selectively advancing the dependency extraction processing for the “b” contact means stopping the dependency extraction processing at the “a” contact.

The seventh embodiment can be carried out in combination with the first to sixth embodiments as appropriate. This enables further narrowing-down of device dependency relations.

### Eighth Embodiment

A program analysis supporting device according to an eighth embodiment is explained. In the following explanation, differences from the first embodiment are mainly explained.

In the first embodiment, the objective is to solve the first problem. In the eighth embodiment, the objective is to further solve the second problem. That is, in the eighth embodiment, as a measure against the second problem, a value of a device memory at the time when an error occurs is stored and extraction processing for device dependency relations that takes into account the value is performed to specify a cause of a deficiency with low reproducibility.

In a production facility, when a defective operation occurs, it is necessary to inform an operator to that effect and urge the operator to perform recovery work. Therefore, in a PC, F devices indicating occurrence of errors are prepared. A ladder program for turning on the respective F devices when various defective operations occur is created.

In the conventional sampling trace, for devices at several points designated in advance, while the sampling trace is always executed, the sampling trace is stopped when a relevant F device is turned on (or when a fixed time or a fixed number of points is reached after the F device is turned on), an obtained sampling trace result is examined, a time series change of values of other devices until the F device is turned on is checked, and a cause of a deficiency is specified.

However, causes for turning on the respective F devices, i.e., the number of the other devices affecting the relevant F device are enormous. Therefore, as explained above, the second problem is present.

The conventional sampling trace includes, as explained above, besides a pre-trigger function for, while always executing the sampling trace, stopping the sampling trace according to satisfaction of a designated trigger condition (or stopping the sampling trace after a fixed time from the satisfaction of the trigger condition), a normal trigger function for starting the sampling trace according to satisfaction of the trigger condition.

Therefore, in the eighth embodiment, making use of this normal trigger function, the turning-on of the F device is set as the trigger condition and, instead of setting the number of sampling points to one, devices to be sampled are set to all samples (all samples within a range in which sampling can be performed). That is, the analysis-condition-setting operation unit 9 sets, as a first condition, a condition that a device, a further forward or backward device dependency relation of which is not extracted, is set as a device of the device memory dump 18.

For example, when two devices are sampled at 8192 points, a sampling capacity for 16383 points is necessary in total. However, even if the sampling capacity is the same, when the number of sampling points is one, values for 16383 devices can be obtained. Therefore, it is possible to roughly grasp an internal state of the PC only at an instance when the relevant F device is turned on.

A sampling trace result obtained in this way can be considered a sampling trace result obtained by dumping a state of the device memory at that instance. If it is impossible to dump all memories in the PC in terms of the capacity, devices affecting a value of the relevant F device set as the trigger of the dump may be selectively dumped. This is a device obtained by extracting backward dependency relations starting from the relevant F device and can be set in advance.

It is possible to narrow down the backward dependency relations by selectively tracing back the devices set as a condition for turning on the relevant device taking into account the device memory dump 18 (see FIG. 2) obtained in this way.

For example, the analysis-condition-setting operation unit 9 sets a device that outputs an abnormality occurrence (e.g., a device F1) as a start point of dependency relations desired to be extracted and instructs the variable-dependency-relation extracting unit 15 to extract a device dependency relation that takes into account the device memory dump 18.

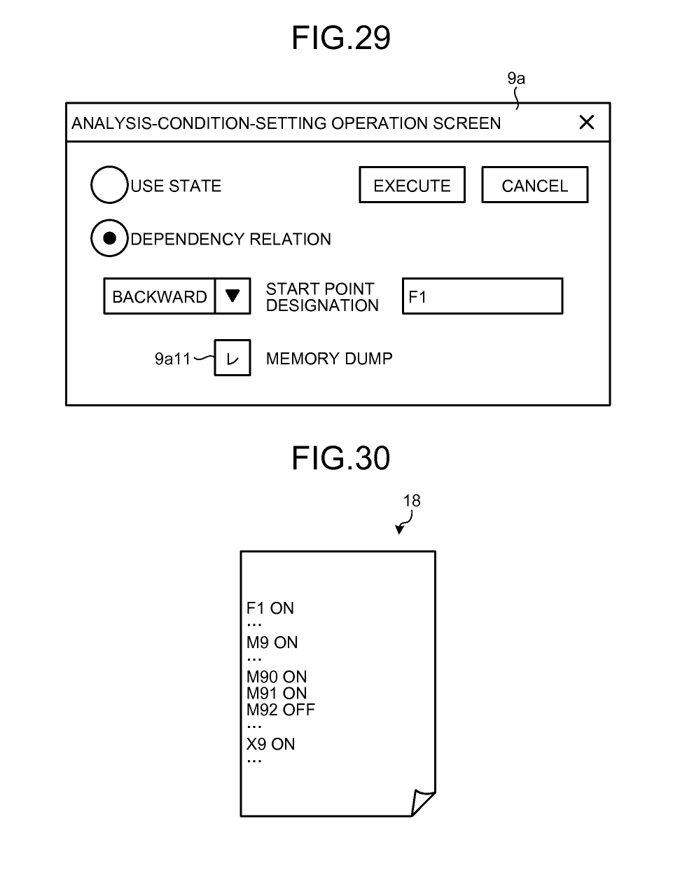

In FIG. 29, a function for not performing further extraction processing for device dependency relations taking into account the device memory dump 18 is checked and enabled.

For example, the analysis-condition-setting operation screen 9a includes a memory dump ON/OFF field 9a11 instead of the type designation ON/OFF field 9a7, the type designation field 9a8, the number-of-times designation ON/OFF field 9a9, and the number-of-times designation field 9a10. The analysis-condition-setting operation screen 9a may include the memory dump ON/OFF field 9a11 in addition to the type designation ON/OFF field 9a7, the type designation field 9a8, the number-of-times designation ON/OFF field 9a9, and the number-of-times designation field 9a10.

In the memory dump ON/OFF field 9a11, it is instructed to perform memory dump designation (i.e., take into account the device memory dump 18) (ON) or not to perform the memory dump designation (OFF). In FIG. 29, as an example, it is instructed to perform the memory dump designation (ON). In the memory dump ON/OFF field 9a11, it may be instructed to perform the memory dump designation (ON) by checking the memory dump ON/OFF field 9a11 and instructed not to perform the memory dump designation by removing the check (OFF).

According to an instruction from the analysis-condition-setting operation unit 9, the variable-dependency-relation extracting unit 15 refers to the device memory dump 18 (see FIG. 2), sets, as a start point, a start point (e.g., the device F1) set by the analysis-condition-setting operation unit 9, and, while taking into account stored contents of the device memory dump 18, extracts a forward or backward device dependency relation and generates a first extraction result. The variable-dependency-relation extracting unit 15 supplies the first extraction result to the variable-dependency-relation-display processing unit 12.

The variable-dependency-relation-display processing unit 12 generates display information using the first extraction result and displays the display information on the display screen 4a. For example, the variable-dependency-relation-display processing unit 12 displays a directed graph shown in the right figure in FIG. 2 on the display screen 4a.

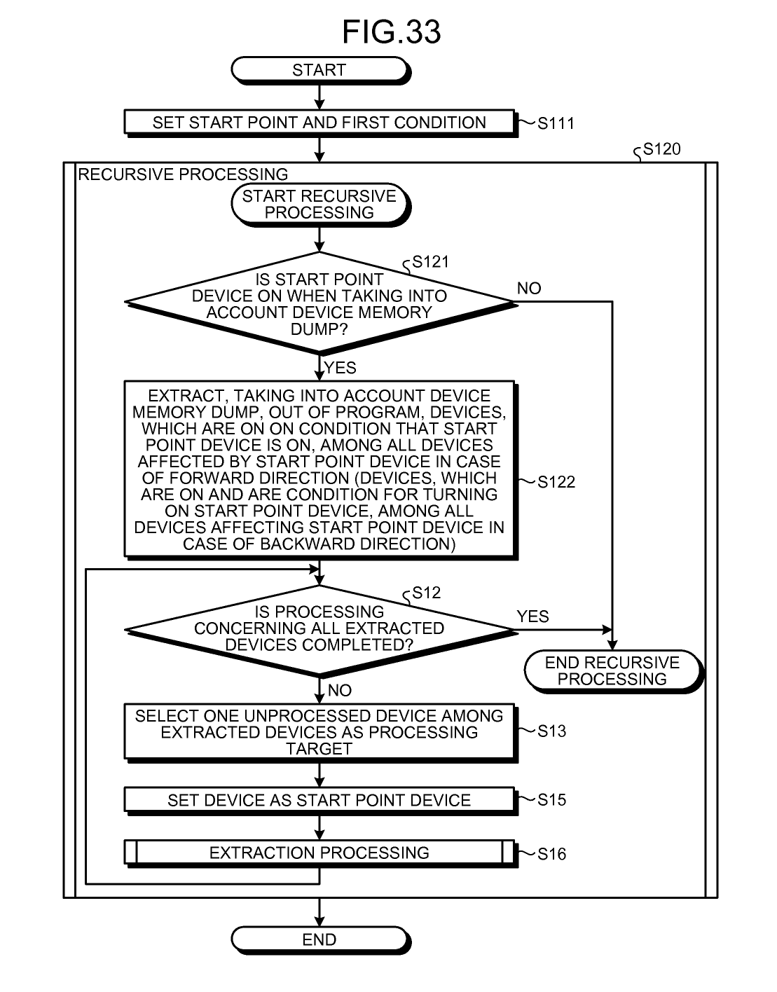

Extraction processing for dependency relations performed when the function for not performing further extraction processing for dependency relations taking into account the device memory dump 18 is checked and enabled is explained using FIG. 33. FIG. 33 is a flowchart illustrating the extraction processing for dependency relations that takes into account the memory dump of devices.

In step S111, the analysis-condition-setting operation unit 9 sets, according to a start point setting instruction received by the operation button 5a or the like in response to the user operation 8, a start point of dependency relations desired to be extracted. For example, in the case shown in FIG. 29, the analysis-condition-setting operation unit 9 sets the device F1 as the start point of dependency relations desired to be extracted. The analysis-condition-setting operation unit 9 supplies information concerning the set start point of dependency relations desired to be extracted to the analysis-processing executing unit 13.

The analysis-condition-setting operation unit 9 sets a second condition according to a second condition setting instruction received by the operation button 5a or the like in response to the user operation 8. For example, in the case shown in FIG. 29, the analysis-condition-setting operation unit 9 sets stored contents of the device memory dump 18 as the second condition. The analysis-condition-setting operation unit 9 supplies information concerning the set second condition to the analysis-processing executing unit 13.

In step S120, the variable-dependency-relation extracting unit 15 performs recursive processing. Specifically, the variable-dependency-relation extracting unit 15 performs processing that is basically the same as the recursive processing in the first embodiment (step S10) but different in the following points.

In step S121, the variable-dependency-relation extracting unit 15 determines, taking into account the device memory dump 18 (see FIGS. 2 and 30), whether the start point device (e.g., the device F1) is turned on. When the start point device is turned on (“Yes” in step S121), the variable-dependency-relation extracting unit 15 advances the processing to step S122. When the start point device is turned off (“No” in step S121), the variable-dependency-relation extracting unit 15 ends the processing.

In step S122, the variable-dependency-relation extracting unit 15 extracts, taking into account the device memory dump 18, dependency relations of devices starting from the start point device (e.g., the device F1) set by the analysis-condition-setting operation unit 9.

For example, when extraction of a forward device dependency relation is designated, the variable-dependency-relation extracting unit 15 extracts, out of the ladder program 16, devices, for which ON of the start point device is a condition, among all devices affected by the start point device. Alternatively, for example, when extraction of a backward device dependency relation is instructed, the variable-dependency-relation extracting unit 15 extracts, out of the ladder program 16, devices, for which ON of the start point device is a condition, among all devices affecting the start point device. The device, for which ON of the start point device is a condition, can be grasped by for example, referring to the device memory dump 18 (see FIG. 30).

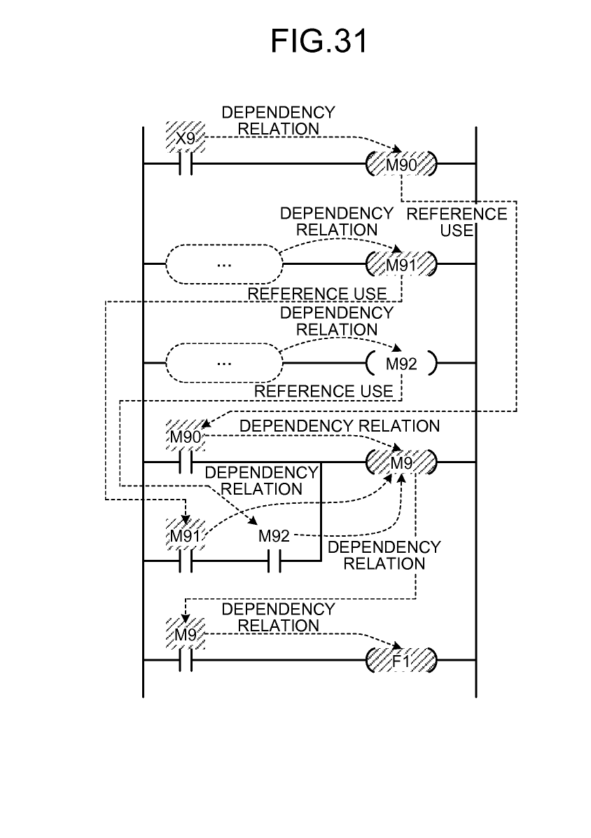

For example, FIG. 30 is the device memory dump 18 acquired according to a trigger condition that the device F1 is turned on. This ON/OFF state is reflected on the ladder program as shown in FIG. 31.

In this case, if a backward dependency relation is extracted starting from the device F1, first, a device M9 is extracted as a device affecting the device F1. If the device memory dump 18 is taken into account, because the device M9 is ON and turns on the device F1, which is a coil in a ladder row of the device M9, the device M9 is further traced back to the device M9.

Subsequently, devices M90, M91, and M92 are extracted as devices affecting the device M9. Because the device M90 is ON and turns on the device M9, which is a coil in a ladder row of the device M90, the device M90 is further traced back to the device M90. On the other hand, although the device M91 is ON, the device M91 does not turn on the device M9, which is a coil of a ladder row of the device M91. This is because, in the ladder, the device M9 is turned on only when both the devices M91 and M92 are ON. Therefore, the device M91 is not further traced back. Because the device M92 is OFF, the device M92 is not further traced back.

Subsequently, a device X9 is extracted as a device affecting the device M90. Because the device X9 is ON and turns on the device M90, which is a coil of a ladder row of the device X9, the device X9 is further traced back to the device X9. However, further dependency relations affecting the device X9 are absent.

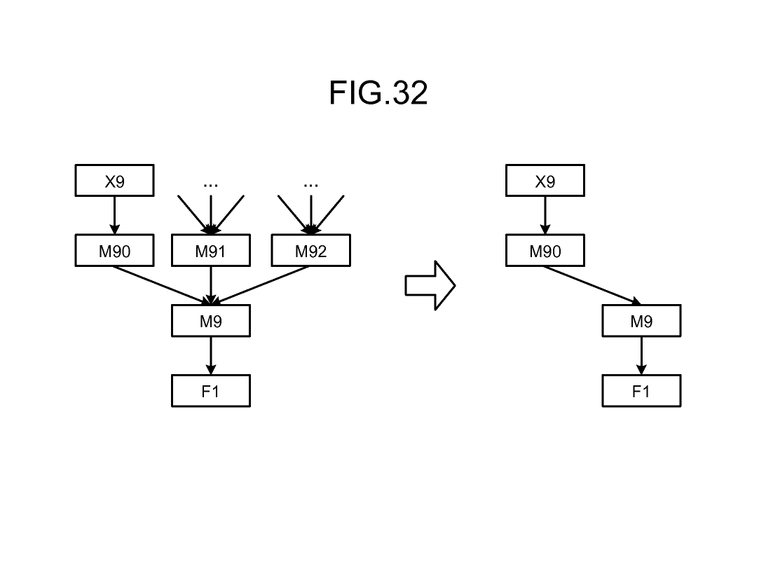

If a backward dependency relation starting from the device F1 is simply extracted, a result shown in the left figure in FIG. 32 is obtained. A narrowed-down result shown in the right figure in FIG. 32 is obtained by checking and enabling the function for not performing further extraction processing for dependency relations taking into account the device memory dump 18.

Consequently, for a deficiency with low reproducibility, it is possible to narrow down devices that are actually a cause of error occurrence out of an enormous number of devices that could be a cause of error occurrence. Therefore, it is possible to solve the second problem.

The device memory itself can be referred to at an arbitrary point in time instead of the device memory dump by the sampling trace function during error occurrence. This is because a difference is only that a reference destination is the device memory dump or the device memory at an arbitrary point in time. In a period from when an error occurs until when the error is stopped after a while, for example, when a state of the devices do not change, there is often no significant difference even if the device memory itself at the point of an error stop is referred to without getting the device memory dump by the sampling trace function during error occurrence.

In the eighth embodiment, in order to trace back causes why the relevant device is ON, whereas a plurality of contacts affecting the coil are present in the ladder program in one row in extraction of the backward dependency relation, if the memory dump is referred to, contacts that actually turn on the coil at that instance are selectively traced back. The same applies when a part caused because the relevant device is ON is delved into. Whereas a plurality of coils affected by a contact because the contact is referred to as the contact in a plurality of ladder programs are present in extraction of the forward dependency relation, if the memory dump is referred to, it is possible to selectively delve into coils actually turned on by the contacts at that instance.

Turned-off devices may be traced back instead of turned-on devices. In the case of a deficiency of error occurrence, because the F device indicating the error occurrence is turned on, in order to search for a cause why the F device is ON, turned-on devices are selectively traced back. However, in the case of a deficiency in which a function that should operate does not operate, a cause why the Y device is not ON, i.e., why the Y device is OFF is sometimes searched. In this case, turned-off devices are selectively traced back.

In addition, if a start point device is designated, when the start point device is ON, turned-on devices may be selectively traced back. When the start point device is OFF, turned-off devices may be selectively traced back. In this case, designation operation for designating whether the turned-on devices are traced back or the turned-off devices are traced back is unnecessary.

The eighth embodiment can be implemented in combination with the first to seventh embodiments as appropriate. This enables further narrowing-down.

As explained above, in the eighth embodiment, the analysis-condition-setting operation unit 9 sets, as a start point of dependency relations desired to be extracted, a device that outputs an abnormality occurrence (e.g., the device F1). The variable-dependency-relation extracting unit 15 extracts, taking into account stored contents of the device memory dump 18, a forward or backward device dependency relation starting from the device that outputs an abnormality occurrence. Consequently, concerning a deficiency with low reproducibility, it is possible to extract and display (a directed graph of) dependency relations deeply related to the deficiency while excluding dependency relations not substantially directly contributing to specify a cause of the deficiency (e.g., the operation of the device). As a result, concerning the deficiency with low reproducibility, it is possible to perform a detailed analysis of operation concerning a defective operation.

### Ninth Embodiment

A program analysis supporting device according to a ninth embodiment is explained. In the following explanation, differences from the first embodiment are mainly explained.

For understanding, display of device dependency relations by a directed graph (display in a block diagram format) is suitable. However, when device dependency relations are enormous and complicated, an advanced user interface is necessary for display operation of the device dependency relation. Therefore, when a personal computer and a PC are connected to perform debug work, there is no problem because the advanced user interface can be realized by a keyboard, a mouse, and a high-resolution display. However, when the debug work is performed using a display and an operation button included in a production facility, a display (display in the block diagram format) operation method by the directed graph of the device dependency relations has to be realized within a limited range of the user interface. Therefore, there is a problem in that, compared with the case of the personal computer, the number of operations markedly increases and, all the worse, more labor and time are required.

Although it is possible to narrow down the enormous and complicated dependency relations by implementing the first to eighth embodiments in combination as appropriate, the display (the display in the block diagram format) operation by the directed graph of the dependency relations within the limited range of the user interface still has to be performed.

The debug work at issue is performed using a production facility subjected to measurement control by a ladder program such as a production facility incorporating a PC and is performed to solve a defective operation. Therefore, a direct object is to quickly specify an error cause rather than analyzing and understanding the structure of an enormous and complicated ladder program.

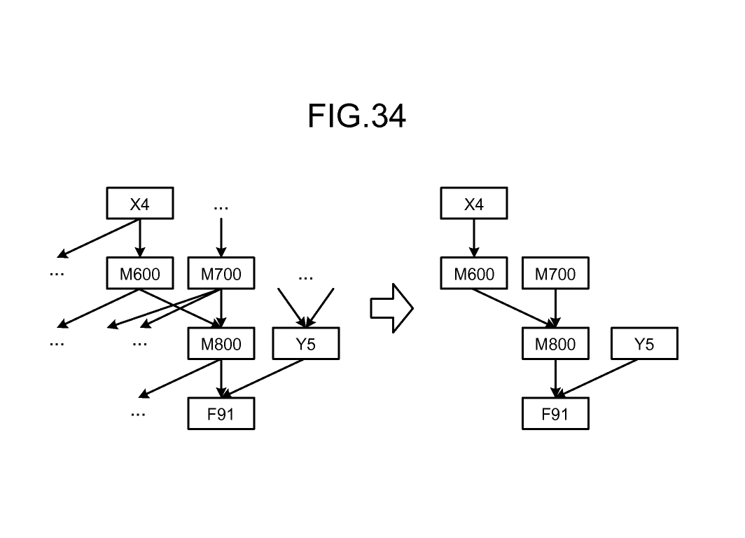

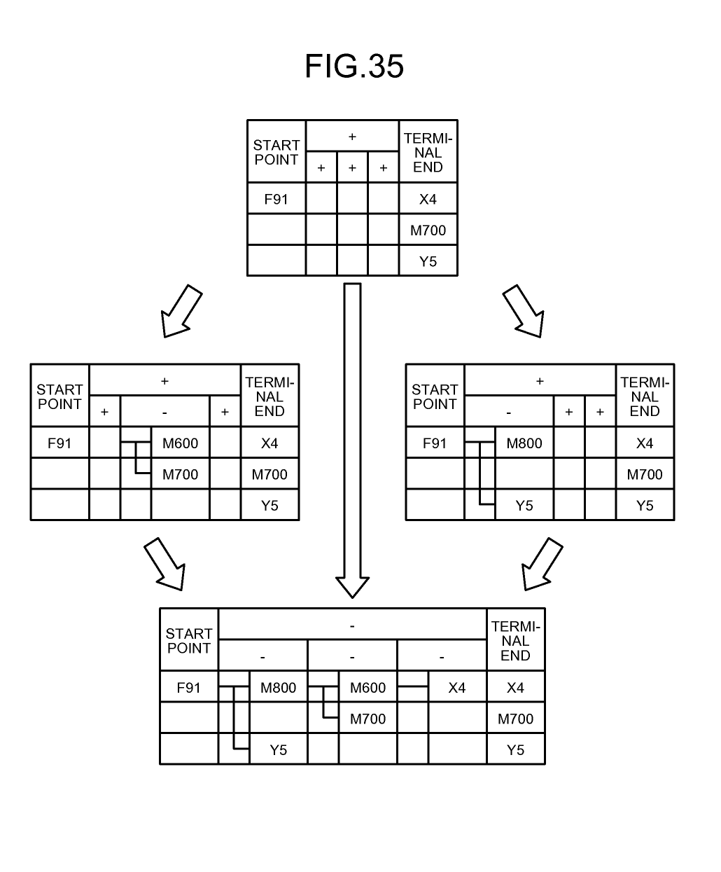

Taking notice of the above, in the ninth embodiment, display halfway in an extracted device dependency relation is omitted and a cause and a result can be selectively displayed. That is, the variable-dependency-relation-display processing unit 12 (see FIG. 2) has a function of selectively displaying a start point device of a device dependency relation and an end point device of the extracted device dependency relation. For example, the variable-dependency-relation-display processing unit 12 displays, in response to the user operation 8, a device dependency relation as shown in FIG. 34 in a display form in which display between the start point device and the end point device of the device dependency relation is omitted as shown in FIG. 35.

Concerning the omitted display halfway in the device dependency relation, buttons for expanding and displaying an omitted part of the display and omitting and closing the expanded and displayed part are separately provided to enable the part to be expanded and displayed for each hierarchy of the device dependency relation. For example, the variable-dependency-relation-display processing unit 12 displays, according to a first extraction result, a start point and an end point of the device dependency relation, and displays, according to expansion and display operation, a halfway device at the middle point between the start point and the end point and omits the display according to a folding display operation instruction. At this point, for example, the variable-dependency-relation-display processing unit 12 displays, for each hierarchy, the halfway device at the middle point between the start point and the end point according to the expansion display operation and omits the display according to the folding display operation instruction. Consequently, it is possible to selectively check an arbitrary part (e.g., an arbitrary hierarchy) desired to be checked in the entire dependency relation.

For example, if the entire device dependency relation is expanded and displayed, this is substantially the same as the display by the directed graph of the device dependency relation (the display in the block diagram format).

According to the ninth embodiment, it is possible to selectively display the start point device of the device dependency relation and the end point device of the extracted device dependency relation. It is possible to quickly specify an error cause even in the range of the limited user interface such as the production facility incorporating the PC.

If extracted dependency relations are enormous and complicated, the number of end point devices is also enormous. However, by implementing the first to eighth embodiments or implementing the first to eighth embodiments in combination as appropriate, it is possible to narrow down the number of terminal end devices of the dependency relations within a realistic range. Therefore, the effects of the ninth embodiment are sufficiently exhibited.

As explained above, in the ninth embodiment, the variable-dependency-relation-display processing unit 12 displays, according to the first extraction result, the start point and the end point of the device dependency relation, and displays, according to the expansion and display operation, the halfway device at the middle point between the start point and the end point of the device dependency relation and omits the display according to the folding display operation. For example, the variable-dependency-relation-display processing unit 12 displays, for each hierarchy, the halfway device at the middle point between the start point and the end point according to the expansion display operation and omits the display according to the folding display operation instruction. Consequently, it is possible to selectively check an arbitrary part (e.g., an arbitrary hierarchy) desired to be checked in the entire dependency relation.

### Tenth Embodiment

A program analysis supporting device according to a tenth embodiment is explained. In the following explanation, differences from the eighth embodiment are mainly explained.

The F devices are prepared as explained in the eighth embodiment. When a defective operation occurs, in order to inform an operator to that effect and urge the operator to perform recovery work, in a production facility, occurrence of an abnormality is displayed on a display unit of the production facility (e.g., Non-Patent Literature 4). At this point, in order to specify where a cause of the abnormality is present, the operator looks at a screen of the abnormality occurrence and then separately checks the F device corresponding to the abnormality, separately sets the F device as an analysis condition, and looks at a dependency relation and a ladder circuit. However, this work is complicated.

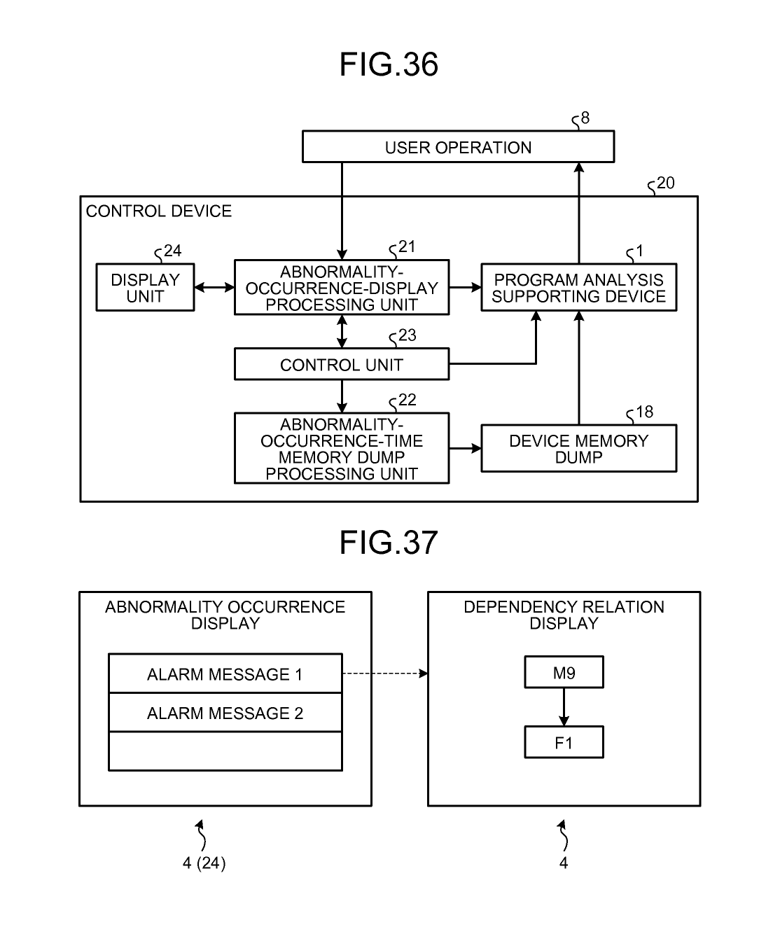

Tanking notice of the above, in the tenth embodiment, as shown in FIG. 36, a control device 20 in the production facility includes the program analysis supporting device 1. When one abnormality display is selected out of abnormality occurrence displays, the control device 20 causes the program analysis supporting device 1 to display a dependency relation starting from the F device corresponding to the abnormality display. At this point, it is also possible to extract a dependency relation taking into account the device memory dump 18 at the time when the abnormality occurs.

For example, the control device 20 includes the program analysis supporting device 1, the device memory dump 18, an abnormality-occurrence-display processing unit 21, a display unit 24, an abnormality-occurrence-time memory dump processing unit 22, and a control unit 23. As the program analysis supporting device 1, for example, the program analysis supporting device according to any one of the first to ninth embodiments can be used. As the device memory dump 18, the device memory dump in the first and eighths embodiments can be used.

When an abnormality occurrence is detected in the ladder program 16 (see FIG. 2), the abnormality-occurrence-display processing unit 21 displays the abnormality occurrence on the display unit 24. The display unit 24 may be a display device such as a liquid crystal display. The abnormality-occurrence-display processing unit 21 displays, for example, one or more abnormality occurrences on the display unit 24. For example, as shown in the left figure in FIG. 37, the abnormality-occurrence-display processing unit 21 displays a plurality of abnormality occurrences on the display unit 24. At this point, the abnormality-occurrence-display processing unit 21 may supply, for example, in response to a request from the control unit 23, display information displayed on the display unit 24 to the program analysis supporting device 1. Consequently, the abnormality-occurrence-display processing unit 21 can display the abnormality occurrences on the display unit 4 of the program analysis supporting device 1 as well.

When recognizing that one abnormality occurrence among the displayed abnormality occurrences is selected in response to the user operation 8, the abnormality-occurrence-display processing unit 21 notifies the program analysis supporting device 1 and the control unit 23 of information concerning the selected abnormality occurrence.

When an abnormality occurrence is detected in the ladder program 16, the abnormality-occurrence-time memory dump processing unit 22 dumps and stores a memory related to a device that outputs the abnormality occurrence (see FIG. 30). The abnormality-occurrence-time memory dump processing unit 22 writes contents of the stored memory dump in the device memory dump 18 periodically or in response to a request from the control unit 23.

The control unit 23 comprehensively controls the units of the control device 20.

For example, when an abnormality occurrence is detected in the ladder program 16, the control unit 23 controls the abnormality-occurrence-display processing unit 21 to display the abnormality occurrence on the display unit 24. At this point, the control unit 23 may control the abnormality-occurrence-display processing unit 21 to supply display information displayed on the display unit 24 to the program analysis supporting device 1.

For example, when an abnormality occurrence is detected in the ladder program 16, the control unit 23 controls the abnormality-occurrence-time memory dump processing unit 22 to dump a memory related to a device that outputs the abnormality occurrence.

For example, the control unit 23 controls the abnormality-occurrence-time memory dump processing unit 22 to write contents of the stored memory dump in the device memory dump 18 at predetermined timing (e.g., timing when the memory dump in the abnormality-occurrence-time memory dump processing unit 22 is assumed to be completed).

For example, when one abnormality occurrence among abnormality occurrences displayed by the abnormality-occurrence-display processing unit 21 is selected, the control unit 23 controls the program analysis supporting device 1 to extract a forward or backward device dependency relation with a device that outputs the selected abnormality occurrence set as a start point of dependency relations desired to be extracted. At this point, the control unit 23 controls the program analysis supporting device 1 to extract, as a condition related to the device that outputs the selected abnormality occurrence, a forward or backward device dependency relation taking into account stored contents of the abnormality-occurrence-time memory dump processing unit 22 concerning the device that outputs the selected abnormality occurrence, i.e., stored contents of the device memory dump 18.

For example, the control unit 23 controls the program analysis supporting device 1 to display the extracted and obtained device dependency relation (see the right figure in FIG. 37). At this point, the control unit 23 may control the program analysis supporting device 1 to display the selected abnormality occurrence and the extracted and obtained device dependency relation in a display form in which the abnormality occurrence and the device dependency relation are associated with each other. For example, in the case of FIG. 37, an alarm message 1 indicating the abnormality occurrence and a directed graph corresponding to the extracted device dependency relation are associated with each other by a broken line arrow extending from the alarm message 1 to the directed graph.

For example, with a display form as shown in FIG. 37, first, it is possible to grasp, in a broad view, a control structure that causes an abnormality occurrence. In order to locally check details of a part desired to be directed attention, it is possible to display a ladder circuit equivalent to the part. Therefore, it is possible to further improve the efficiency of the work for specifying a cause of abnormality.

As explained above, in the tenth embodiment, in the control device 20, the control unit 23 controls, when one abnormality occurrence among abnormality occurrences displayed by the abnormality-occurrence-display processing unit 21 is selected, the program analysis supporting device 1 to extract a forward or backward device dependency relation with a device that outputs the selected abnormality occurrence set as a start point of dependency relations desired to be extracted and display the obtained device dependency relation. Consequently, concerning a deficiency with low reproducibility, it is possible to extract and display (a directed graph of) dependency relations deeply related to the deficiency while excluding dependency relations not substantially directly contributing to specify a cause of the deficiency (e.g., the operation of the device). As a result, concerning the deficiency with low reproducibility, it is possible to perform a detailed analysis of operation concerning a defective operation.

In the tenth embodiment, in the control device 20, the control unit 23 controls, when one abnormality occurrence among abnormality occurrences displayed by the abnormality-occurrence-display processing unit 21 is selected, the program analysis supporting device 1 to set a device that outputs the selected abnormality occurrence as a start point of dependency relations desired to be extracted, extract, as a condition related to the device that outputs the selected abnormality occurrence, a forward or backward device dependency relation taking into account stored contents of the abnormality-occurrence-time memory dump processing unit 22 concerning the device that outputs the selected abnormality occurrence, and display the obtained device dependency relation. At this point, for example, the control unit 23 controls the program analysis supporting device 1 to display the selected abnormality occurrence and the extracted and obtained device dependency relation in a display form in which the abnormality occurrence and the device dependency relation are associated with each other. Consequently, it is possible to first grasp, in a broad view, a control structure that causes an abnormality occurrence. In order to locally check details of a part desired to be directed attention, it is possible to display a ladder circuit equivalent to the part. Therefore, it is possible to further improve the efficiency of the work for specifying a cause of abnormality.

### INDUSTRIAL APPLICABILITY

As explained above, the program analysis supporting device according to the present invention is useful for an analysis of a deficiency of a ladder program.

### REFERENCE SIGNS LIST

1 program analysis supporting device
2 microprocessor
3 data storage memory
4 display unit
5 input unit
6 storing unit
7 system bus
8 user operation
9 analysis-condition-setting operation unit
10 analysis-result-display processing unit
11 variable-use-state-display processing unit
12 variable-dependency-relation-display processing unit
13 analysis-processing executing unit
14 variable-use-state extracting unit
15 variable-dependency-relation extracting unit
16 ladder program
17 device comment
18 device memory dump
19 circuit-display processing unit
20 control device
21 abnormality-occurrence-display processing unit
22 abnormality-occurrence-time memory dump processing unit
23 control unit
24 display unit

1. A program analysis supporting device comprising:
an analysis-condition-setting operation unit that sets a ladder program to be analyzed and a start point of a dependency relation desired to be extracted;
an analysis-processing executing unit that includes a variable-dependency-relation extracting unit that extracts a forward or backward device dependency relation from the ladder program;
an analysis-result-display processing unit that includes a variable-dependency-relation-display processing unit that displays the extracted device dependency relation; and
a circuit-display processing unit that displays the ladder program, wherein
the analysis-condition-setting operation unit sets a first condition related to a device for which a further forward or backward device dependency relation is not extracted or a second condition related to a device for which a further forward or backward device dependency relation is extracted,
the variable-dependency-relation extracting unit extracts a forward or backward device dependency relation from the ladder program starting from the set start point not to extract a further forward or backward device dependency relation concerning a device matching the first condition and to extract a further forward or backward device dependency relation concerning a device matching the second condition and generates a first extraction result, and
the variable-dependency-relation-display processing unit displays a device dependency relation according to the first extraction result.

2. The program analysis supporting device according to claim 1, wherein the circuit-display processing unit, when one device is designated out of a device dependency relation displayed according to the first extraction result, selectively displays a ladder circuit that coil-outputs the designated device or selectively displays, while displaying an entire device dependency relation conforming to the first extraction result, a ladder circuit that coil-outputs the designated device.

3. The program analysis supporting device according to claim 1, wherein
the variable-dependency-relation extracting unit separately extracts, concerning an end point device in a device dependency relation conforming to the first extraction result, a device dependency relation starting from the end point device and generates a second extraction result, and
the variable-dependency-relation-display processing unit divides, based on the first extraction result and the second extraction result, a device dependency relation starting from a start point set by the analysis-condition-setting operation unit into two or more device dependency relations and displays the device dependency relations.

4. The program analysis supporting device according to claim 1, wherein the variable-dependency-relation-display processing unit displays a start point and an end point of a device dependency relation according to the first extraction result, and displays a device halfway at a middle point between the start point and the end point according to an expansion display operation and omits display of the device according to a folding display operation instruction.

5. The program analysis supporting device according to claim 1, wherein
the analysis-processing executing unit further includes a variable-use-state extracting unit that extracts, from the ladder program, concerning a device, a histogram concerning number of times the device is referred to and used as a contact in a plurality of ladder rows or number of times indicating from how many contacts a control dependency is received in one ladder row such that the histogram serves as reference information when setting the first condition, and
the analysis-result-display processing unit further includes a variable-use-state-display processing unit that displays the extracted histogram.

6. A control device comprising:
a program analysis supporting device that includes
an analysis-condition-setting operation unit that sets a ladder program to be analyzed and a start point of a dependency relation desired to be extracted,
an analysis-processing executing unit that includes a variable-dependency-relation extracting unit that extracts a forward or backward device dependency relation from the ladder program,
an analysis-result-display processing unit that includes a variable-dependency-relation-display processing unit that displays the extracted device dependency relation, and
a circuit-display processing unit that displays the ladder program, in which
the analysis-condition-setting operation unit sets a first condition related to a device for which a further forward or backward device dependency relation is not extracted or a second condition related to a device for which a further forward or backward device dependency relation is extracted,
the variable-dependency-relation extracting unit extracts a forward or backward device dependency relation from the ladder program starting from the set start point not to extract a further forward or backward device dependency relation concerning a device matching the first condition and to extract a further forward or backward device dependency relation concerning a device matching the second condition and generates a first extraction result, and
the variable-dependency-relation-display processing unit displays a device dependency relation according to the first extraction result;
an abnormality-occurrence-display processing unit that displays, when an abnormality occurrence is detected in the ladder program, the abnormality occurrence; and
a control unit that controls the program analysis supporting device such that, when one abnormality occurrence among abnormality occurrences displayed by the abnormality-occurrence-display processing unit is selected, a device that outputs the selected abnormality occurrence is set as a start point of a dependency relation desired to be extracted, and an obtained device dependency relation is displayed.

7. The control device according to claim 6, further comprising an abnormality-occurrence-time memory dump processing unit that dumps and stores, when an abnormality occurrence is detected in the ladder program, a memory related to a device that outputs the abnormality occurrence, wherein
the control unit controls the program analysis supporting device such that, when one abnormality occurrence among abnormality occurrences displayed by the abnormality-occurrence-display processing unit is selected, a device that outputs the selected abnormality occurrence is set as a start point of a dependency relation desired to be extracted, extraction of a further forward or backward device dependency relation is designated by taking into account a stored content of the abnormality-occurrence-time memory dump processing unit concerning the device that outputs the selected abnormality occurrence as a condition related to the device that outputs the selected abnormality occurrence, and an obtained device dependency relation is displayed.
